(19) United States
(12) Patent Application Publication
(10) Pub. No.: US 2025/0097878 A1
(43) Pub. Date: Mar. 20, 2025

(54) INDICATING RELATIVE POSITION AND SIDELINK SYNCHRONIZATION SIGNAL IDENTIFIER OF USER EQUIPMENT

(71) Applicant: QUALCOMM Incorporated, San Diego, CA (US)

(72) Inventors: Sundervelu Palanivelu TANDALAM, San Diego, CA (US); Ahmed SADEQUE, San Diego, CA (US); Cheol Hee PARK, San Diego, CA (US); Santosh Kumar RONGALA, San Diego, CA (US); Praveen Kumar APPANI, San Diego, CA (US); Sean Vincent MASCHUE, Encinitas, CA (US); Srinivasan RAJAGOPALAN, San Diego, CA (US)

(21) Appl. No.: 18/467,266

(22) Filed: Sep. 14, 2023

(51) Int. Cl. H04W 64/00; H04W 56/00

(52) U.S. Cl. CPC H04W 64/00; H04W 56/0015

(57) ABSTRACT

Various aspects of the present disclosure generally relate to wireless communication. In some aspects, a user equipment (UE), such as a roadside unit (RSU), located in an area of limited or no global navigation satellite system (GNSS) coverage may circulate sidelink synchronization signal (SLSS) neighbor information, such as in the form of an SLSS neighbors list (SNL). The SLSS neighbor information may include one or more of an index number, an SLSS identifier (ID), a timing source in-coverage flag, an RSU ID, a hop ID, a geographic location, a transmission synchronization offset, a synchronization source, and/or a coordinated universal time (UTC) time.

### FIELD OF THE DISCLOSURE

Aspects of the present disclosure generally relate to wireless communication and specifically, to techniques and apparatuses for indicating a relative position and a sidelink synchronization signal identifier of a user equipment.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth or transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

A deadlock scenario can arise when a user equipment (UE) in sidelink synchronization signal (SLSS) synchronization mode synchronizes with one or more other UEs, and none of the synchronized UEs are synchronized to a global navigation satellite system (GNSS) for timing. For example, a roadside unit (RSU) in an area without GNSS coverage (e.g., a tunnel) may go down, preventing the RSU from forwarding GNSS synchronization information to other RSUs in the area. As a result, the other RSUs may synchronize with each other for frame timing, drifting away from GNSS synchronization over time. Moreover, a cellular vehicle-to-everything (C-V2X) device may be unable to obtain the coordinated universal time (UTC) from over the air (OTA) when the C-V2X device is in SLSS synchronization mode in GNSS-challenged areas. Furthermore, a UE may perform SLSS muting, which may involve the UE stopping transmissions of SLSS at certain occasions to attempt to decode SLSS signals from other synchronization sources. Additionally, a UE may not connect to an optimal (e.g., closest) RSU synchronization source in the area without GNSS coverage.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to receive a first indication including at least a sidelink synchronization signal (SLSS) identifier associated with a neighboring UE of the UE and an indication of a relative position of the neighboring UE within a plurality of UEs. At least one processor of the one or more processors may be configured to cause the UE to transmit a second indication including at least an SLSS identifier associated with the UE and an indication of a relative position of the UE within the plurality of UEs.

Some aspects described herein relate to a method of wireless communication performed at a UE. The method may include receiving a first indication including at least an SLSS identifier associated with a neighboring UE of the UE and an indication of a relative position of the neighboring UE within a plurality of UEs. The method May include transmitting a second indication including at least an SLSS identifier associated with the UE and an indication of a relative position of the UE within the plurality of UEs.

Some aspects described herein relate to a non-transitory computer-readable medium storing a set of instructions for wireless communication. The set of instructions may include one or more instructions. The one or more instructions, when executed by one or more processors of a UE, may cause the UE to receive a first indication including at least a sidelink synchronization signal identifier associated with a neighboring UE of the UE and an indication of a relative position of the neighboring UE within a plurality of UEs. The one or more instructions, when executed by one or more processors of the UE, may cause the UE to transmit a second indication including at least an SLSS identifier associated with the UE and an indication of a relative position of the UE within the plurality of UEs.

Some aspects described herein relate to an apparatus for wireless communication. The apparatus may comprise means for receiving a first indication including at least an SLSS identifier associated with a neighboring apparatus of the apparatus and an indication of a relative position of the neighboring apparatus within a plurality of apparatuses. The apparatus may comprise means for transmitting a second indication including at least an SLSS identifier associated with the apparatus and an indication of a relative position of the apparatus within the plurality of apparatuses.

Aspects generally include a method, apparatus, system, computer program product, non-transitory computer-readable medium, user equipment, base station, network node, network entity, wireless communication device, or processing system as substantially described with reference to and as illustrated by the drawings and specification.

The foregoing has outlined rather broadly the features and technical advantages of examples in accordance with the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network in accordance with the present disclosure.

FIG. 2 is a diagram illustrating an example network node in communication with a user equipment (UE) in a wireless network in accordance with the present disclosure.

FIG. 3 is a diagram illustrating an example of sidelink synchronization signal (SLSS) capable devices, in accordance with the present disclosure.

FIG. 4 is a diagram illustrating an example of SLSS propagation in a daisy chain, in accordance with the present disclosure.

FIG. 5 is a diagram illustrating an example of a deadlock scenario, in accordance with the present disclosure.

FIG. 6 is a diagram illustrating an example of synchronization source selection, in accordance with the present disclosure.

FIG. 7 is a diagram illustrating an example associated with indicating a relative position of a UE with an associated SLSS identifier, in accordance with the present disclosure.

FIG. 8 is a diagram illustrating an example associated with initializing an SLSS neighbors list (SNL) by propagating SNL information across a system, in accordance with the present disclosure.

FIG. 9 is a diagram illustrating an example associated with propagating SNL information across a system when the SNL is in a stable state, in accordance with the present disclosure.

FIG. 10 is a diagram illustrating an example associated with mitigating deadlock, in accordance with the present disclosure.

FIG. 11 is a diagram illustrating an example associated with cloud-based implementations, in accordance with the present disclosure.

FIG. 12 is a diagram illustrating an example associated with determining a hop identifier for a UE, in accordance with the present disclosure.

FIG. 13 is a diagram illustrating an example associated with mitigating deadlock using a hop identifier, in accordance with the present disclosure.

FIG. 14 is a diagram illustrating an example associated with SLSS propagation in a daisy chain using a hop identifier, in accordance with the present disclosure.

FIG. 15 is a diagram illustrating an example of a deadlock scenario involving hop identifiers, in accordance with the present disclosure.

FIG. 16 is a diagram illustrating an example of a continuation of the deadlock scenario involving hop identifiers, in accordance with the present disclosure.

FIG. 17 is a diagram illustrating an example of a further continuation of the deadlock scenario involving hop identifiers, in accordance with the present disclosure.

FIG. 18 is a diagram illustrating an example of synchronization source selection, in accordance with the present disclosure.

FIG. 19 is a flowchart illustrating an example process performed, for example, by a UE that supports indicating a relative position and an SLSS identifier of the UE, in accordance with the present disclosure.

FIG. 20 is a diagram of an example apparatus for wireless communication that supports indicating a relative position and an SLSS identifier for a UE, in accordance with the present disclosure.

### DETAILED DESCRIPTION

Various aspects of the disclosure are described more fully hereinafter with reference to the accompanying drawings. This disclosure may, however, be embodied in many different forms and are not to be construed as limited to any specific structure or function presented throughout this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or combined with any other aspect of the disclosure. For example, an apparatus may be implemented or a method may be practiced using any quantity of the aspects set forth herein. In addition, the scope of the disclosure is intended to cover such an apparatus or method which is practiced using other structure, functionality, or structure and functionality in addition to or other than the various aspects of the disclosure set forth herein. Any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Lack of global navigation satellite system (GNSS) coverage can lead to deadlock scenarios, inaccurate coordinated universal time (UTC) times, sidelink synchronization signal (SLSS) muting, and/or connections to suboptimal roadside units (RSUs). A deadlock scenario can arise when UEs in SLSS synchronization mode synchronize with each other, and none of the synchronized UEs are synchronized to a GNSS for timing. For example, an RSU in an area without GNSS coverage (e.g., a tunnel) may fail, preventing the RSU from forwarding GNSS synchronization information to other RSUs in the area. As a result, the other RSUs may synchronize with each other for frame timing, drifting away from GNSS synchronization over time. Moreover, a cellular vehicle-to-everything (C-V2X) device may be unable to obtain the coordinated universal time (UTC) from over the air (OTA) when the C-V2X device is in SLSS synchronization mode in GNSS-challenged areas. Furthermore, a user equipment (UE) may perform SLSS muting, which may involve the UE stopping transmissions of SLSS at certain occasions to attempt to decode SLSS signals from other synchronization sources. Additionally, a UE may not connect to an optimal (e.g., closest) RSU synchronization source in the area without GNSS coverage.

Various aspects relate generally to timing synchronization (e.g., using SLSSs). Some aspects more specifically relate to timing synchronization in C-V2X implementations with limited or no GNSS coverage. In some aspects, a plurality of UEs, such as RSUs, located in an area of limited or no GNSS coverage may circulate SLSS neighbor information, such as in the form of an SLSS neighbors list (SNL). The SLSS neighbor information may include one or more of an index number, an SLSS identifier (ID), a timing source in-coverage flag, an RSU ID, a hop ID, a geographic location, a transmission synchronization offset (e.g., a synchronization offset used for transmission of SLSSs, such as an SLSS synchronization offset), a synchronization source, and/or a UTC time.

In some aspects, a UE may receive a first indication including an SLSS ID associated with a neighboring UE (e.g., a neighboring RSU). In some examples, the first indication may further include an indication of a time (e.g., a UTC time), such as a time at which the neighboring UE generated the first indication. In some examples, the first indication may further include a transmission synchronization offset associated with the neighboring UE. In some examples, the first indication may further include an indication of a relative position of the neighboring UE within a plurality of UEs. For example, the indication of the relative position may include a hop ID of the neighboring UE. The UE may receive the first indication from the neighboring UE or from a cloud or a network.

The UE may transmit a second indication including at least an SLSS identifier associated with the UE and an indication of a relative position of the UE within the plurality of UEs. In some examples, the second indication may further include an indication of a time (e.g., a UTC time), such as a time at which the UE generated the second indication. In some examples, the second indication may further include a transmission synchronization offset associated with the UE. In some examples, the second indication may further include an indication of a relative position of the UE within a plurality of UEs. For example, the indication of the relative position may include a hop ID of the UE. The UE may transmit the second indication to another neighboring UE or to a cloud or a network.

Particular aspects of the subject matter described in this disclosure can be implemented to realize one or more of the following potential advantages. In some examples, by receiving the first indication (e.g., a first SNL) and/or transmitting the second indication (e.g., a second SNL), the described techniques can be used to resolve deadlock scenarios by enabling a UE to determine whether that UE is in a deadlock scenario (e.g., based on whether an SNL contains an SLSS ID 0). For example, the indication of the relative position of a UE including a hop ID of the UE may help to prevent UEs from synchronizing among one another in the absence of a link to a GNSS-synchronized UE, and thus avoid a deadlock.

The first indication and/or the second indication further including an indication of a time (e.g., a UTC time) may resolve the UTC timing issues by enabling a UE to identify a UTC time. The first and/or second indication further including a transmission synchronization offset may resolve the SLSS muting issues by enabling a UE to identify overlapping SLSS transmissions (e.g., based on SLSS ID, transmission synchronization offset, or the like) without attempting to measure signals from neighboring UEs. The first and/or second indication further including the indication of the relative position(s) may resolve issues relating to UEs not connecting to closest synchronization sources by enabling a UE to identify (e.g., based on RSU ID, location, or the like) which RSU is, or will be, closest to the UE. For example, the indication of the relative position of a UE including a hop ID of the UE may assist a UE in selecting a SLSS synchronization source having the smallest timing offset.

Receiving the first indication from a cloud or network may help to reduce the inter-transmit time of the first indication, as the UE may receive untruncated SNLs from the cloud. Moreover, transmitting the second indication to a cloud or network may enable the cloud or network to transmit an SNL message to a mobile UE. For example, a vehicle may download an SNL from the cloud or network before entering an area with limited or no GNSS coverage (e.g., a tunnel).

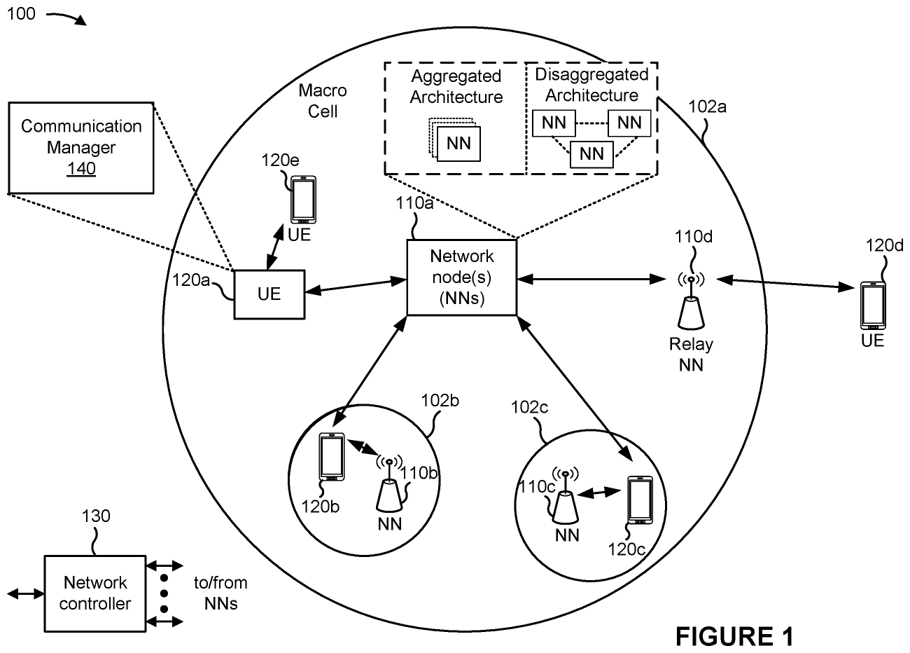

FIG. 1 is a diagram illustrating an example of a wireless network in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node (NN) 110a, a network node 110b, a network node 110c, and a network node 110d), a UE 120 or multiple UEs 120 (shown as a UE 120a, a UE 120b, a UE 120c, a UE 120d, and a UE 120e), or other network entities. A network node 110 is an entity that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, or one or more DUs. A network node 110 may include, for example, an NR network node, an LTE network node, a Node B, an eNB (for example, in 4G), a gNB (for example, in 5G), an access point, or a transmission reception point (TRP), a DU, an RU, a CU, a mobility element of a network, a core network node, a network element, a network equipment, and/or a RAN node. In some examples, the network nodes 110 may be interconnected to one another or to one or more other network nodes 110 in the wireless network 100 through various types of fronthaul, midhaul, or backhaul interfaces, such as a direct physical connection, an air interface, or a virtual network, using any suitable transport network.

Each network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used.

A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts). In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), and/or a Non-Real Time (Non-RT) RIC. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

A network controller 130 may couple to or communicate with a set of network nodes 110 and may provide coordination and control for these network nodes 110. The network controller 130 may communicate with the network nodes 110 via a backhaul communication link. The network nodes 110 may communicate with one another directly or indirectly via a wireless or wireline backhaul communication link. In some aspects, the network controller 130 may be a CU or a core network device, or the network controller 130 may include a CU or a core network device.

In some examples, a cell may not necessarily be stationary, and the geographic area of the cell may move in accordance with the location of a network node 110 that is mobile (for example, a mobile network node). In some examples, the network nodes 110 may be interconnected to one another or to one or more other network nodes 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (for example, a network node 110 or a UE 120) and send a transmission of the data to a downstream station (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay network node, or a relay.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any quantity of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some examples, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “Sub-6 GHz” band in various documents and articles. A similar nomenclature issue sometimes occurs in connection with FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHZ-300 GHz). Each of these higher frequency bands falls within the EHF band.

With the above examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may receive a first indication including at least an SLSS identifier associated with a neighboring UE of the UE 120 and an indication of a relative position of the neighboring UE within a plurality of UEs; and transmit a second indication including at least an SLSS identifier associated with the UE 120 and an indication of a relative position of the UE 120 within the plurality of UEs. Additionally, or alternatively, the communication manager 140 may perform one or more other operations described herein.

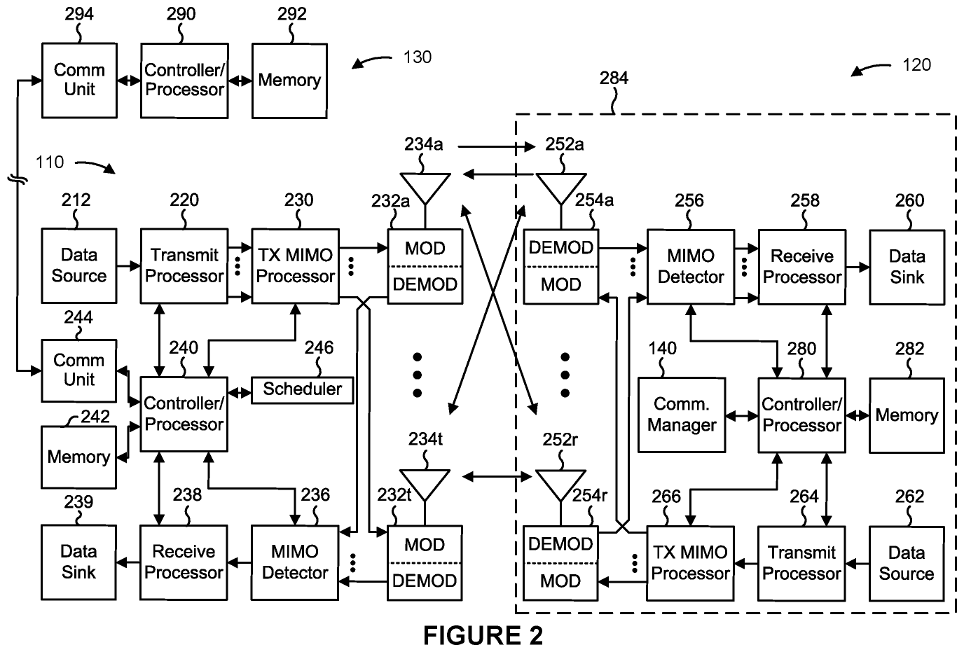

FIG. 2 is a diagram illustrating an example network node in communication with a UE in a wireless network in accordance with the present disclosure. The network node may correspond to the network node 110 of FIG. 1. Similarly, the UE may correspond to the UE 120 of FIG. 1. The network node 110 may be equipped with a set of antennas 234a through 234t, such as T antennas (T≥1). The UE 120 may be equipped with a set of antennas 252a through 252r, such as R antennas (R≥1). The network node 110 of depicted in FIG. 2 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (for example, encode and modulate) the data for the UE 120 based at least in part on the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 May generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers and/or one or more processors. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the methods described herein.

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the methods described herein.

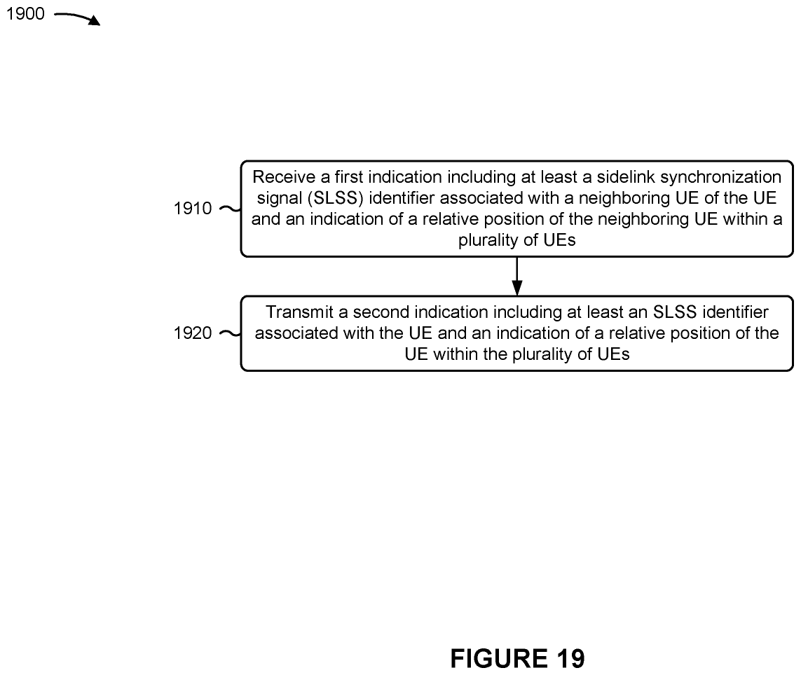

The controller/processor 240 of the network node 110, the controller/processor 280 of the UE 120, or any other component(s) of FIG. 2 may perform one or more techniques associated with indicating a relative position and an SLSS ID of a UE, as described in more detail elsewhere herein. For example, the controller/processor 240 of the network node 110, the controller/processor 280 of the UE 120, or any other component(s) of FIG. 2 may perform or direct operations of, for example, process 1900 of FIG. 19 or other processes as described herein. The memory 242 and the memory 282 may store data and program codes for the network node 110 and the UE 120, respectively. In some examples, the memory 242 or the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 1900 of FIG. 19 or other processes as described herein. In some examples, executing instructions may include running the instructions, converting the instructions, compiling the instructions, or interpreting the instructions, among other examples. In some implementations, one or more of the multiple memories may be configured to store processor-executable code that, when executed, may configure the one or more processors to perform various functions described herein (as part of a processing system). In some other implementations, the processing system may be pre-configured to perform various functions described herein.

In some aspects, the UE 120 includes means for receiving a first indication including at least an SLSS identifier associated with a neighboring UE of the UE 120 and an indication of a relative position of the neighboring UE within a plurality of UEs; and/or means for transmitting a second indication including at least an SLSS identifier associated with the UE 120 and an indication of a relative position of the UE 120 within the plurality of UEs. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, and/or one or more RUs).

An aggregated base station (for example, an aggregated network node) may be configured to utilize a radio protocol stack that is physically or logically integrated within a single RAN node (for example, within a single device or unit). A disaggregated base station (for example, a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

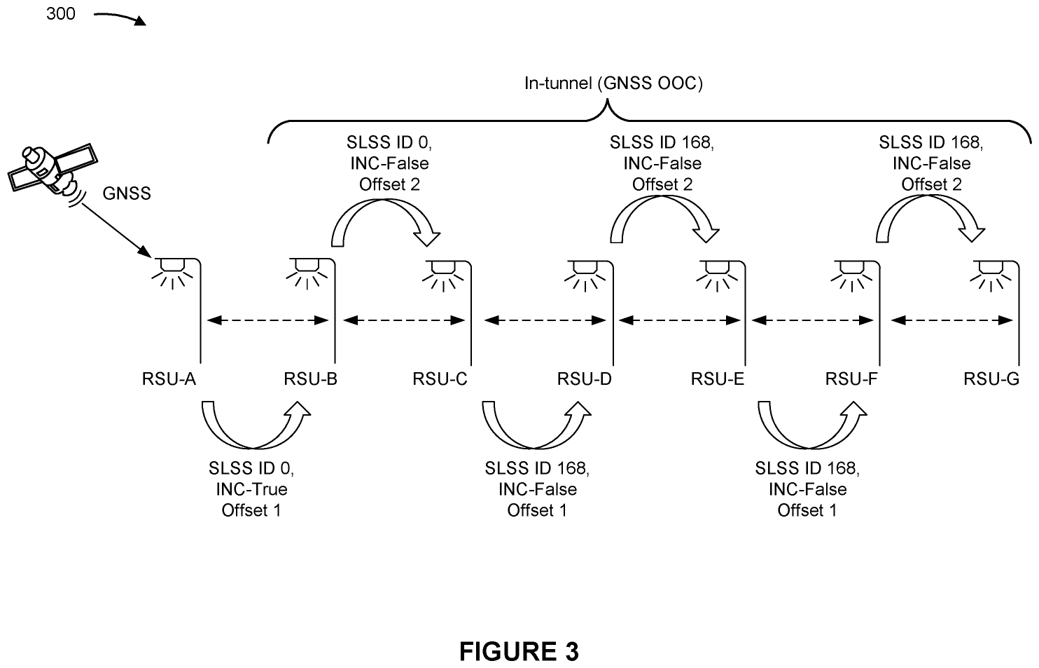

FIG. 3 is a diagram illustrating an example 300 of SLSS-capable devices, in accordance with the present disclosure.

The GNSS may be used as the primary synchronization source in C-V2X implementations. However, in some places, such as tunnels, parking garages, or the like, there is no GNSS coverage. In the absence of GNSS coverage, SLSSs may be used to maintain C-V2X frame timing and keep C-V2X implementations operational. For example, SLSS-capable devices may be deployed as RSUs in places where there is no GNSS coverage.

When SLSSs are used for timing in C-V2X mode 4, there are three unique SLSS IDs that may be derived based on the DMRS sequence: SLSS ID 0, which may correspond to a device that is using GNSS as a synchronization source; SLSS ID 168, which may correspond to a device that is configured for two SLSS offset indicators and is not in GNSS coverage; and SLSS ID 169, which may correspond to a device that is configured for three SLSS offset indicators and is not in GNSS coverage.

SLSS ID 0 may be exclusive, while SLSS IDs 168 or 169 may be used by all other SLSS transmission devices in a given system. For example, FIG. 3 shows RSUs A-G, each of which may be configured to transmit an SLSS. Because RSUs D-G use the same SLSS ID and in-coverage flag status (“INC-False”), a UE may be unable to identify the source of an SLSS.

As a result, all RSUs after the fourth hop (e.g., RSU D) have the same synchronization source priority, which may determine which SLSS a UE (e.g., a vehicular UE) uses. Furthermore, an SLSS receiving device (e.g., a vehicular UE) may be unable to determine which SLSS source to use for timing. Priority may be assigned to a received
SLSS based on the source for GNSS-based synchronization as follows:
P0: GNSS
P1: UE (e.g., RSU) directly synchronized to GNSS
P2: UE indirectly synchronized to GNSS
P6: Remaining UEs, which may have the lowest priority
P7: UE internal clock

Table 1 below indicates priorities assigned based on properties of SLSS sources.

TABLE 1

| Priority | SLSS source |
|---|---|
| 1 | GNSS |
| 2 | SLSS ID = 0 && inCoverage = True |
| | SLSS ID = 0 && syncOffsetIndicator3 && |
| | incoverage = FALSE |
| 3 | SLSS ID = 0 && inCoverage = False && Non |
| | syncOffsetIndicator3 |
| 4 | SLSS ID = 169 && inCoverage = False |
| | SLSS ID = 168 && inCoverage = False |

While the deployment scenarios depicted in FIG. 3 and other figures described herein involve two SLSS offsets, techniques described herein may additionally or alternatively apply to deployment scenarios involving three SLSS offsets.

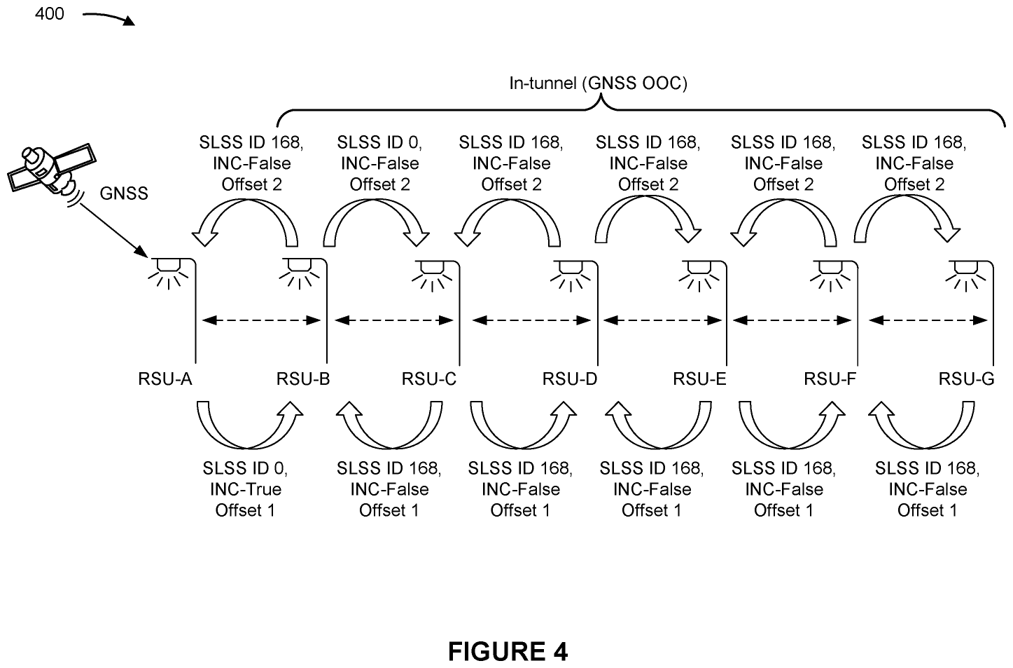

FIG. 4 is a diagram illustrating an example 400 of SLSS propagation in a daisy chain, in accordance with the present disclosure.

As shown in FIG. 4, an RSU deep inside a tunnel (e.g., RSU G) may be time-synchronized with the rest of the system (e.g., RSUs A-F and the GNSS). The arrows pointing left-to-right represent target propagation of SLSSs, and the arrows pointing right-to-left represent leakage (e.g., undesirable reception of SLSSs) from adjacent SLSS sources.

Table 2 below shows the SLSS sources that are decodable on a given UE. For example, Table 2 shows the decoded SLSS source per RSU ID, which may correspond to an SLSS-receiving UE. Table 2 also shows identifiers for a decoded SLSS. For example, the identifiers may be the SLSS ID and the SyncOffsetsubframe on which the SLSS was decoded, which may correspond to the offset.

TABLE 2

| SLSS | RSU ID | | | | | | |
|---|---|---|---|---|---|---|---|
| source | RSU A | RSU B | RSU C | RSU D | RSU E | RSU F | RSU G |
| 1 | ID168 | ID0 | ID168 | ID168 | ID168 | ID168 | ID168 |
| | Offset2 | Offset1 | Offset2 | Offset1 | Offset2 | Offset1 | Offset2 |
| 2 | | ID168 | ID168 | ID168 | ID168 | ID168 | ID168 |
| | | Offset1 | Offset2 | Offset1 | Offset2 | Offset1 | Offset2 |

Thus, based on the priorities discussed above in connection with FIG. 3, from RSU C onward, all of the decoded SLSS sources have the same priority. RSRP may be the only criterion that is used to determine the SLSS source, when multiple SLSS sources have the same SLSS priorities. Since the RSUs receive and transmit SLSS sources, and C-V2X is a half-duplex technology, a UE may receive an SLSS on one SLSS offset occasion and transmit on the other SLSS offset occasion.

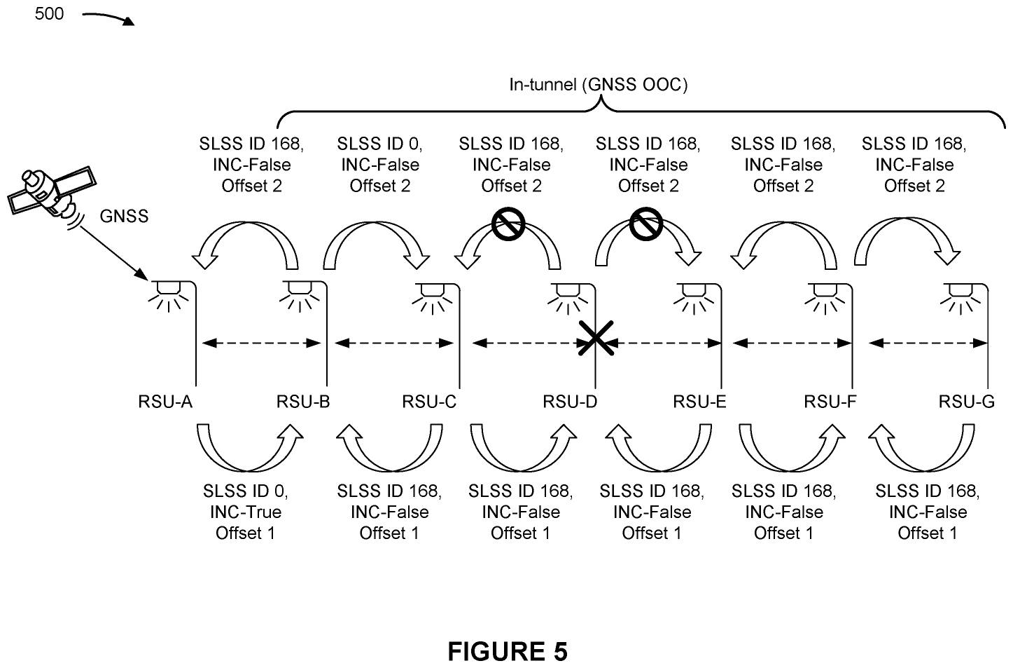

FIG. 5 is a diagram illustrating an example 500 of a deadlock scenario, in accordance with the present disclosure.

In example 500, RSU D may go down. Table 3 below shows the decoded SLSSs received from adjacent SLSS-transmitting UEs when RSU D is down. For example, Table 3 shows the decoded SLSS sources per RSU ID, in the event of a deadlock, which may correspond to an SLSS-receiving UE.

TABLE 3

| SLSS | RSU ID | | | | | | |
|---|---|---|---|---|---|---|---|
| source | RSU A | RSU B | RSU C | RSU D | RSU E | RSU F | RSU G |

| | | | | | | |
|---|---|---|---|---|---|---|
| 1 | ID168 | ID0 | ID168 | ID168 | ID168 | ID168 |
| | Offset2 | Offset1 | Offset2 | Offset2 | Offset1 | Offset2 |
| 2 | | ID168 | | | ID168 | ID168 |
| | | Offset1 | | | Offset1 | Offset2 |

RSU E may begin to use RSU F as the timing synchronization source because RSU-F is the only SLSS source for RSU E. As a result, RSU E, RSU F and RSU G are synchronized with each other for frame timing, creating a timing synchronization deadlock. As time goes by, RSUs E-G drift away from the GNSS-synchronized RSUs (e.g., RSUs A-C) for timing synchronization. The drift may grow sufficiently large such that, when RSU D returns online, RSU E is unable to detect and synchronize back with RSU D. The lack of synchronization with respect to RSUs E-G may, in turn, create issues for on-board units (OBUs) that depend on the timing provided by the RSUs for transmitting messages (e.g., basic safety messages (BSMs)). For example, OBUs synchronized with RSU C will not be able to interoperate with OBUs synchronized with RSUs E-G, creating potentially hazardous conditions for drivers.

A UE (e.g., any of RSUs E-G) may be unable to determine whether a timing source is derived from a GNSS-connected UE (e.g., RSU A). Furthermore, a UE may be unable to determine whether the UE has entered a deadlock scenario.

Moreover, a C-V2X device may be unable to obtain the UTC time from OTA when the C-V2X device is in an SLSS synchronization mode in GNSS-challenged areas. However, ITS stacks may require millisecond-level timing accuracy to generate a message. Without UTC time, the ITS stacks may be unable to generate a message with millisecond-level timing accuracy. For example, when a device performs a cold boot in a location, such as a parking garage, with no wireless wide area network (WWAN) or GNSS coverage, the device may be unable to obtain the UTC time. Additionally, when a device moves from a region with GNSS coverage into a region with no GNSS coverage, GNSS engines can continue to maintain system clocks using dead reckoning (DR) systems, but not for extended durations. For example, over time, time accuracy will decrease (e.g., the DR time will drift from the UTC time).

Furthermore, when an SLSS device is using one offset for SLSS reception, the SLSS device may use the other offset for SLSS transmission. For example, a UE (e.g., an RSU) that transmits an SLSS in a subframe may be unable to decode any SLSS signals. As a result, the UE may be unable to decode SLSS signals from synchronization sources that are higher priority than the current synchronization source and/or from synchronization sources that are stronger than the current synchronization source. The UE may perform SLSS muting, by which the UE stops transmissions of SLSS at certain occasions to attempt to decode SLSS signals from other synchronization sources, but SLSS muting can lead to dropped SLSS transmissions.

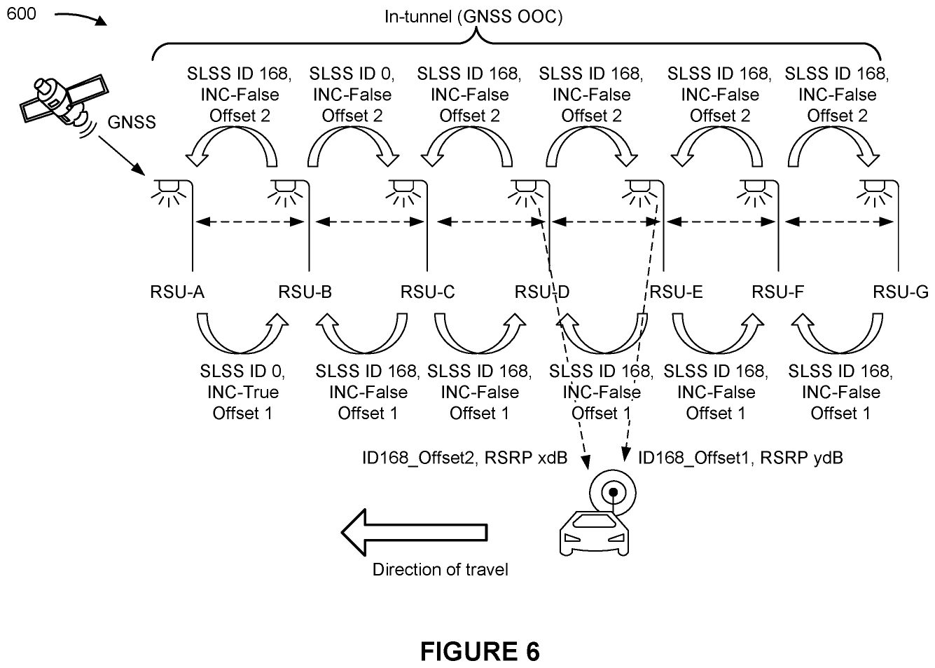

FIG. 6 is a diagram illustrating an example 600 of synchronization source selection, in accordance with the present disclosure.

An OBU may select an SLSS source based on RSRP. However, in some examples, the OBU may decode multiple SLSS sources with similar RSRPs. For example, an OBU driving by two RSUs may detect similar RSRPs from the RSUs, but one RSU may have a higher timing offset (TO) than the other. As shown in FIG. 6, the OBU is unable to distinguish between RSRPs corresponding to RSU D and RSU E. As a result, the OBU may select the RSU E as the SLSS source, even though RSU E is (or will soon be) associated with a higher TO than RSU D based on the direction of travel of the OBU.

Moreover, RSUs (e.g., a receiving SLSS UE) may, depending on channel conditions and deployment, select a UE that is farther from the GNSS for synchronization over a UE that is closer to the GNSS. For example, an RSU may select the farther UE if the RSRPs of the farther UE and the closer UE are indistinguishable. For example, if the RSU E detects a same or stronger power from RSU F compared to that from RSU-D, then the RSU E may select RSU F for timing. As a result, RSU E may experience a total TO of approximately 6 us when synchronized to RSU F versus approximately 4 us when synchronized to RSU D.

Various aspects relate generally to timing synchronization (e.g., using SLSSs). Some aspects more specifically relate to timing synchronization in C-V2X implementations with limited or no GNSS coverage. In some aspects, UEs (e.g., RSUs) located in an area of limited or no GNSS coverage may circulate SLSS neighbor information, such as in the form of an SNL. The SLSS neighbor information may include one or more of an index number, an SLSS ID, a timing source in-coverage flag, an RSU ID, a hop ID, a geographic location, a transmission synchronization offset, a synchronization source, and/or a UTC time.

Particular aspects of the subject matter described in this disclosure can be implemented to realize one or more of the following potential advantages. In some examples, the described techniques can be used to resolve the deadlock scenario, location and UTC timing issues, SLSS muting issues, and/or issues relating to UEs not connecting to closest synchronization sources, as discussed above in connection with FIGS. 5 and 6. The SLSS neighbor information may resolve the deadlock scenario by enabling an RSU to determine whether that RSU is in a deadlock scenario (e.g., based on whether an SNL contains an SLSS ID 0). The SLSS neighbor information may resolve the location and UTC timing issues by enabling a UE to identify a location and/or UTC time (e.g., based on geographic location and/or UTC time). The SLSS neighbor information may resolve the SLSS muting issues by enabling a UE to identify overlapping SLSS transmissions (e.g., based on SLSS ID, transmission synchronization offset, or the like) without attempting to measure signals from neighboring UEs. The SLSS neighbor information may resolve issues relating to UEs not connecting to closest synchronization sources by enabling a UE to identify (e.g., based on RSU ID, location, or the like) which RSU is, or will be, closest to the UE.

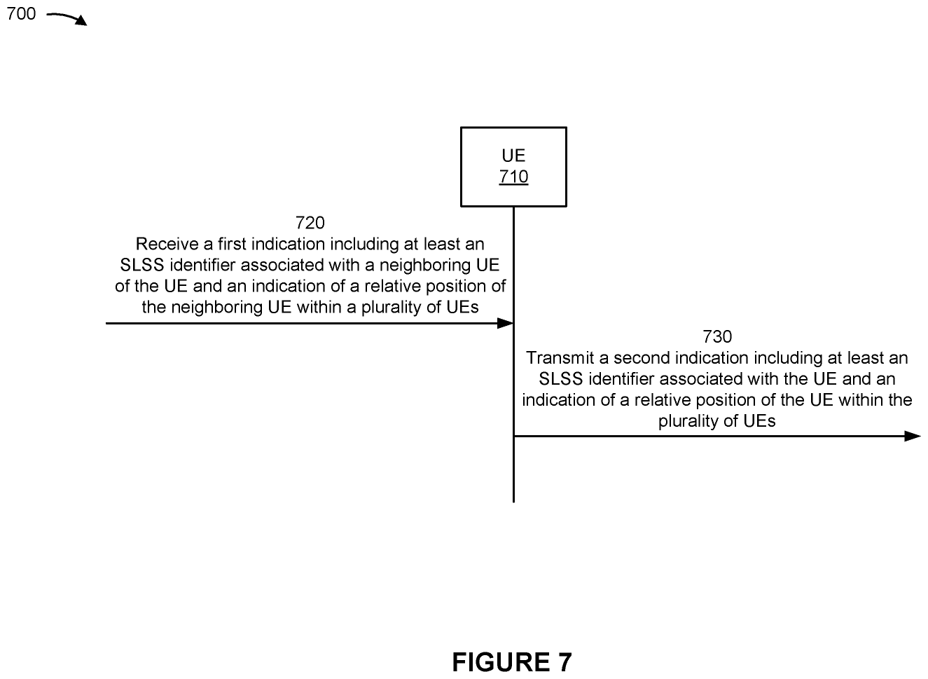

FIG. 7 is a diagram illustrating an example 700 associated with indicating a relative position of a UE with an associated SLSS ID, in accordance with the present disclosure. Example 700 may involve communications transmitted to and from a UE 710 (e.g., an RSU).

As shown by reference number 720, the UE 710 receives a first indication including at least an SLSS identifier associated with a neighboring UE (e.g., a neighboring RSU) of the UE 710 and an indication of a relative position of the neighboring UE within a plurality of UEs. The neighboring UE may be within a threshold distance or quantity of hops from the UE 710. In some examples, the neighboring UE may be adjacent to the UE 710. The plurality of UEs may be a plurality of RSUs that include the UE 710 and the neighboring UE. In some examples, the plurality of UEs may be located in an area of little or no GNSS coverage, such as a tunnel, parking garage, or the like.

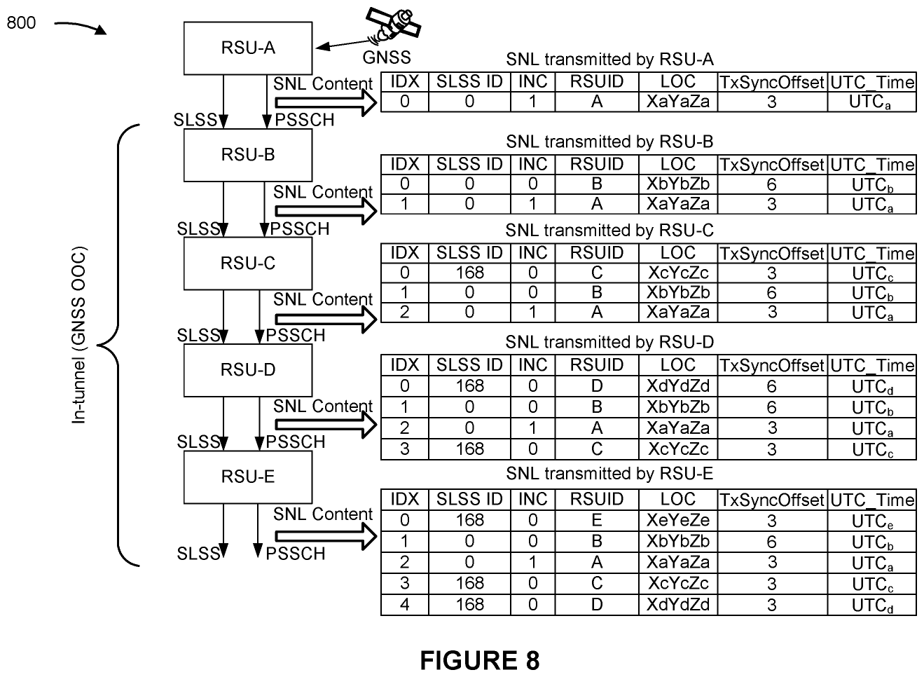

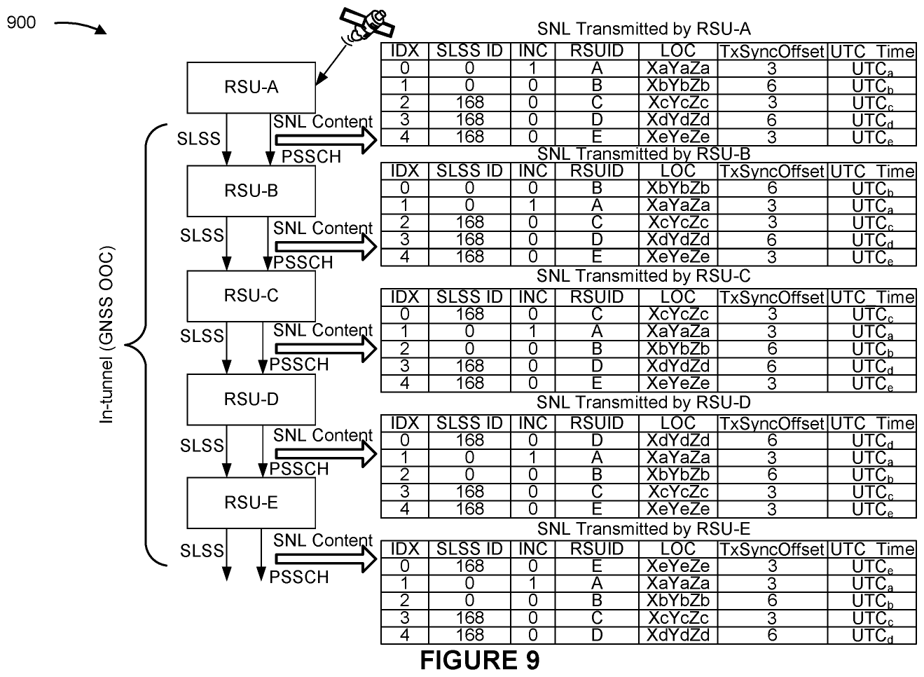

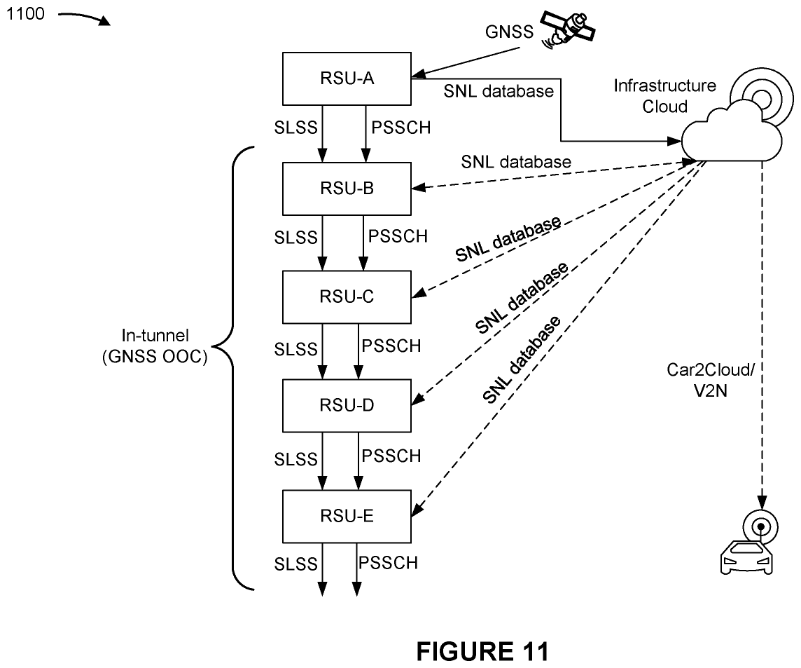

In some examples, the UE 710 may receive the first indication from the neighboring UE, as discussed in greater detail below in connection with FIGS. 8 and 9. In some examples, the UE 710 may receive the first indication from a cloud or a network, as discussed in greater detail below in connection with FIG. 11. The indication of the relative position of the neighboring UE may indicate a topological placement of the neighboring UE within the plurality of UEs. For example, the indication of the relative position of the neighboring UE may include an identifier (e.g., an RSU ID) of the neighboring UE, a hop ID of the neighboring UE, a geographic location of the neighboring UE, or the like. In some examples, the first indication may further include an indication of a time (e.g., a UTC time), such as a time at which the neighboring UE generated the first indication, and/or a transmission synchronization offset associated with the neighboring UE.

As shown by reference number 730, the UE 710 transmits a second indication including at least an SLSS identifier associated with the UE 710 and an indication of a relative position of the UE 710 within the plurality of UEs. In some examples, the UE 710 may transmit the second indication to another neighboring UE, as discussed in greater detail below in connection with FIGS. 8 and 9. In some examples, the UE 710 may transmit the second indication to the cloud or the network, as discussed in greater detail below in connection with FIG. 11.

The indication of the relative position of the UE 710 may indicate a topological placement of the UE 710 within the plurality of UEs. For example, the indication of the relative position of the UE 710 may include an identifier (e.g., an RSU ID) of the UE 710, a hop ID of the UE 710, a geographic location of the UE 710, or the like. In some examples, the second indication may further include an indication of a time (e.g., a UTC time), such as a time at which the UE 710 generated the second indication, and/or a transmission synchronization offset associated with the UE 710.

In some examples, the first indication may comprise a first list (e.g., a first SNL), and/or the second indication may comprise a second list (e.g., a second SNL). Tables 4 and 5 below provide example SNLs. While the information provided in Tables 4 and 5 is presented as lists (e.g., SNLs), the information may be provided in any other suitable format.

TABLE 4

| IDX | SLSS ID | INC | RSU ID | LOC | TxSyncOffset | UTC Time |
|---|---|---|---|---|---|---|
| 0 | 0 | 1 | A | XaYaZa | 3 | UTCa |
| 1 | 0 | 0 | B | XbYbZb | 6 | UTCb |
| 2 | 168 | 0 | C | XcYcZc | 3 | UTCc |
| 3 | 168 | 0 | D | XdYdZd | 6 | UTCd |
| 4 | 168 | 0 | E | XeYeZe | 3 | UTCe |
| 5 | 168 | 0 | F | XfYfZf | 6 | UTCf |

TABLE 5

| | SLSS | | RSU | | | TxSync | Sync | |
|---|---|---|---|---|---|---|---|---|
| IDX | ID | INC | ID | HopID | LOC | Offset | Source | UTC Time |
| 0 | 0 | 1 | A | 0 | XaYaZa | 3 | | UTCa |
| 1 | 0 | 0 | B | 1 | XbYbZb | 6 | 0 | UTCb |
| 2 | 168 | 0 | C | 2 | XcYcZc | 3 | 1 | UTCc |
| 3 | 168 | 0 | D | 3 | XdYdZd | 6 | 2 | UTCd |
| 4 | 168 | 0 | E | 4 | XeYeZe | 3 | 3 | UTCe |
| 5 | 168 | 0 | F | 5 | XfYfZf | 6 | 4 | UTCf |

As shown, the SNL may include, for each UE (e.g., the UE 710, neighboring UEs, or the like), an index (“IDX”), an SLSS ID, an indication of whether the UE is in coverage of a navigation system, such as a GNSS (e.g., an in-coverage flag (“INC”)), an identifier (“RSU ID”), a hop ID (“HopID”), a geographic location (“LOC”), a transmission synchronization offset (“TxSyncOffset”), a synchronization source indication (“Sync Source”), and/or an indication of a time, such as a UTC time (“UTC time”).

IDX 0 may be associated with the ego SLSS information (e.g., SLSS information associated with the transmitting device), and IDX 1 and onward may be associated with SLSS information associated with neighboring devices (e.g., neighbor list information). For example, the device that generates and transmits the SNL message may occupy IDX 0.

The SLSS ID may be identify an SLSS timing source and may be decoded based on a primary synchronization signal (PSS) and a secondary synchronization signal (SSS). The INC may be an SLSS timing source in-coverage flag decoded from the physical sidelink broadcast channel (PSBCH). The RSU ID may identify the SLSS transmission synchronization source. The RSU ID may be a medium access control (MAC) source ID, such as a self-assigned and/or random L2 MAC source address. The HopID may be selected by each UE and included in the SNL message (e.g., transmitted in the PSBCH).

The LOC may be a GNSS location (e.g., latitude and longitude) that provides an accuracy of approximately 100 m. In some examples, the accuracy may be greater than or less than approximately 100 m. The LOC may be set as a preconfigured location, based on cached location information, dynamically derived (e.g., using DR), or the like.

The TxSyncOffset may indicate the synchronization offset used for transmission of the SLSS. The SyncSource may indicate the hop ID of the UE that is used as a synchronization source for a given UE. The UTC Time may be the UTC time when the SNL message was generated. In some examples, the SNL may further include a TimingOffset field, which may contain, for each UE, an estimated timing offset of the SLSS timing source.

Thus, the SNL may include a list of all neighboring SLSS synchronization sources. In some aspects, a plurality of UEs may be in SLSS synchronization and may transmit, via a physical sidelink shared channel (PSSCH) once every one or more SLSS cycles, a plurality of lists (e.g., SNLs) that include indications of a plurality of synchronization sources. For example, the SNL may be transmitted over a PSSCH as an event-driven message once every X ms in an SNL cycle. The SNL may be associated with proximity service per-packet priority (PPPP) (e.g., a lowest PPPP). For instance, every SLSS transmission device (e.g., the plurality of UEs) may generate an SNL. In some examples, the UE 710 may use a semi-persistent scheduling (SPS) flow to generate the SNL (e.g., to populate a table), and switch to event-driven flow after generating the SNL.

In some aspects, the UE 710 may generate the second list (e.g., an SNL) for transmission by appending information to the first list (e.g., an SNL) received by the UE 710. For example, while generating an SNL, the UE 710, having previously decoded an SNL from the neighboring UE, may append unique information from the previous SNL before transmitting the SNL. In some examples, the unique information may include a tuple containing [SLSS ID, INC, RSU ID, LOC, TxSyncOffset]. In some examples, the tuple may also include a hop ID. The UE 710 may remove an entry from the SNL if an SNL containing that entry has not been decoded for a threshold quantity of SNL cycles.

Receiving the first indication (e.g., a first SNL) and/or transmitting the second indication (e.g., a second SNL) may resolve a deadlock scenario by enabling the UE 710 and/or a neighboring UE to determine whether that UE is in a deadlock scenario (e.g., based on whether the first indication, or the second indication, contains an SLSS ID 0). The first indication and/or the second indication further including an indication of a time (e.g., a UTC time) may resolve the location and UTC timing issues by enabling a UE (e.g., UE 710, a neighboring UE, or the like) to identify the geographic location and/or UTC time. The first and/or second indication further including a transmission synchronization offset may resolve the SLSS muting issues by enabling a UE (e.g., UE 710, a neighboring UE, or the like) to identify overlapping SLSS transmissions (e.g., based on SLSS ID, transmission synchronization offset, or the like) without attempting to measure signals from neighboring UEs. The first and/or second indication including the indication of the relative position(s), and/or further including the geographic location, may enable a UE (e.g., UE 710, a neighboring UE, an OBU, or the like) to identify (e.g., based on RSU ID, geographic location, or the like) which RSU is, or will be, closest to that UE.

FIG. 8 is a diagram illustrating an example 800 associated with initializing the SNL by propagating SNL information across a system, in accordance with the present disclosure. The system may include RSUs A-G, which, in some examples, may be spaced 200-300 meters from each other, corresponding to a timing delay of 1 μs. However, RSUs A-G may be spaced any suitable distance and have any suitable corresponding timing delay.

The RSU that uses the GNSS as a time source (e.g., RSU A) may generate the SNL message before the other RSUs. RSU A may transmit the message, and devices within range of the RSU A (e.g., RSU B) may decode the SNL message. Devices may decode SLSS signals and choose the initial synchronization signal.

In example 800, a UE (e.g., an RSU) may receive a first list (e.g., a first SNL) that associates a first index (e.g., IDX 0) with an SLSS ID associated with a neighboring UE and with an indication of a relative position of the neighboring UE within a plurality of UEs. For example, RSU B may receive the SNL transmitted by RSU A, RSU C may receive the SNL transmitted by RSU B, and so forth.

The UE may transmit a second list (e.g., a second SNL) that associates the first index (e.g., IDX 0) with an SLSS ID associated with the UE and with an indication of a relative position of the UE within the plurality of UEs. The second list may further associate a second index (e.g., IDX 1, IDX 2, or the like) with the SLSS ID associated with the neighboring UE and associated with the indication of the relative position of the neighboring UE. In some aspects, a UE may append information to the first list using the first index. For example, a device that is using an SLSS may receive an SNL message, append information associated with the device in the SNL (e.g., table) utilizing IDX 0, and generate and transmit an SNL message. Thus, for each transmitted SNL, IDX 0 corresponds to the RSU that is transmitting the SNL. For example, in the SNL transmitted by RSU A, IDX 0 corresponds to RSU A, and in the SNL transmitted by RSU B, IDX 0 corresponds to RSU B and IDX 1 corresponds to RSU A, and so forth.

Associating the first index (e.g., IDX 0) with the transmitting UE may indicate, to the receiving UE, which UE among the plurality of UEs transmitted the SNL. For example, the receiving UE may identify the transmitting UE and determine that the SNL information (e.g., SLSS ID, INC, or the like) is associated with the transmitting UE.

The total time for a tunnel system to reach equilibrium (time-to-equilibrium, TTE) may depend on whether there is an RSU directly connected to the GNSS on both entrances of the tunnel. In some examples, TTEa=c×t×n/g, where c is the number of cycles before an RSU ID is included or deleted in an SNL, t is the SNL transmit periodicity, n is the total number of RSUs in the chain, and g is the number of RSUs (or UEs) in GNSS synchronization. For example, if an RSU is directly connected to the GNSS on both entrances of the tunnel, then TTEa=c×t×n/2. If only one RSU is directly connected to the GNSS (e.g., at one entrance of the tunnel), then TTE_{b}=c×t×n.

FIG. 9 is a diagram illustrating an example 900 associated with propagating SNL information across a system when the SNL is in a stable state, in accordance with the present disclosure.

As shown, once all devices (e.g., RSUs) in the system are transmitting SNL messages, the SNL messages from all devices in the system may contain identical information (except for the UTC time). The system may be in a steady state when there are no additions or deletions to the list after a threshold quantity of minutes of initialization. If there is an addition or deletion of a row in the SNL after the system has reached the steady state, a UE may transmit an updated SNL message that reflects the addition or deletion (e.g., the UE may immediately send the updated SNL message).

In some examples, if the SNL message exceeds a threshold message size, the system may truncate the SNL. For example, the UE may truncate the SNL to a minimum of three entries, including an entry for the UE, one or more entries for any adjacent (decodable) neighbors, and one or more entries for any priority 1 SLSS synchronization sources. The RSU(s) connected to the GNSS may set the threshold message size.

The generated SNL message may be built at the intelligent transportation system (ITS) stack or independently in the C-V2X modem software stack. ITS stack signing of messages may help to verify the validity of the SNL message that is being decoded. In some examples, the received MAC source ID of a verified ITS stack signed message may be cross-verified against the received MAC source ID while decoding the transport block containing the SNL message. In some examples, an SNL message may be signed at the high-level operating system (HLOS).

As noted above, a UE (e.g., an RSU) may receive a first indication (e.g., a first SNL) that includes a first indication of a first time (e.g., a first UTC time) and transmit a second indication (e.g., a second SNL) that includes a second indication of a second time (e.g., a second UTC time). In some examples, where a UE is directly connected to the GNSS (e.g., RSU A), the UE may use the UTC time derived from the GNSS in the SNL message transmitted by that UE. In some examples, the UE may receive an indication of the time over a WWAN, such as via SIB16 (for LTE) or SIB9 (for 5G NR). However, a UE that does not receive an indication of time (e.g., UTC time) directly from a global positioning system (GPS) or WWAN may derive the UTC time from the received SNL message. In some aspects, the UE may derive a UTC time associated with the UE using a UTC time, associated with a neighboring UE, carried in the first indication, and generate the second indication by appending the UTC time associated with the UE to the first indication. For example, RSU B may derive the UTC time from the SNL message received from RSU A, RSU C may derive the UTC time from the SNL message received from RSU B, and so forth. A transmitting UE (e.g., a UE that is out of coverage (OOC) of the GNSS) that is generating an SNL message may derive the UTC time and/or location and append the derived (e.g., calculated) UTC time and/or location. For example, the transmitting UE may update the UTC time column each time the transmitting UE generates an SNL message.

The transmitting UE may derive the UTC time based on the relation UTCtime_{calculated}=SNL_{UTC}+CorrectionFactor, where SNL_{UTC} is the latest decoded UTC time indicated in IDX 0 of the most recent SNL message received by the transmitting UE, and CorrectionFactor=(OTA_{DFN}−SNL_{DFN})+Interstackdelay+TOest, where OTA_{DFN} is a direct frame number (DFN) derived based on the system frame number (SFN) and/or system frame (SF) of the decoded SNL message, SNL_{DFN} is a DEN derived based on SNL_{UTC}, Interstackdelay is a UE interstack delay that is constant for each device, and TOest is an estimated TO (e.g., an estimated timing delay).

A UE that has not decoded an SNL message may not adjust the UTC time or apply the UTC time at the HLOS. A UE may derive the UTC time based on the UTC time in the most recent SNL message that the UE decoded. In some aspects, the UE may decode a plurality of indications and identify a UTC time from an indication, of the plurality of indications, that the UE decoded more recently than any other indications of the plurality of indications. The UE may obtain information regarding the location of the UE. Using the location in the SNL message, the UE may determine a closest UTC synchronization time source. The GNSS-based location in the SNL message may help the UE determine an approximate geo-location, which may be applied for geo-polygon features.

Receiving R the first indication of the first time and transmitting the second indication of the second time may help UEs (e.g., vehicular UEs) to obtain a UTC time in GNSS-challenged areas. For example, a device in a location with no WWAN or GNSS coverage (e.g., a device that performs a cold boot in a parking garage or enters a region without GNSS coverage) may obtain the UTC time. As a result, the ITS stacks may generate messages with millisecond-level timing accuracy.

In some aspects, a UE (e.g., an RSU) may identify one or more parameters of one or more SLSS transmissions based at least in part on an indication that includes at least an SLSS ID associated with a neighboring UE and an indication of a relative position of the neighboring UE within a plurality of UEs. For example, based on information in the SNL (e.g., SLSS ID, RSU ID, LOC, UTC Time, TxSyncOffset, or the like), SLSS-transmitting UEs may identify overlapping SLSS transmissions. In some aspects, the UE may identify overlapping SLSS transmissions using the indication. For example, the UEs may identify the overlapping SLSS transmissions without performing SLSS muting.

Thus, SLSS-transmitting devices (e.g., UEs) may switch SLSS sources without stopping (e.g., muting) SLSS transmissions. For example, the UEs may switch SLSS sources without randomly monitoring for other SLSS synchronization sources that the UE could use. As a result, the UEs may avoid dropping or not transmitting SLSS signals due to SLSS muting. Moreover, by not measuring neighboring UEs, a UE may avoid channel estimation required when, thereby unburdening UE compute resources.

In some aspects, a mobile (e.g., vehicular) UE may identify a synchronization source from among a plurality of UEs (e.g., a plurality of RSUs) in accordance with the first indication (e.g., the first SNL) or the second indication (e.g., the second SNL). For example, an SNL message received by the mobile UE may enable the mobile UE to perform preemptive actions based on the SLSS synchronization sources (e.g., RSUs) along the path of the mobile UE. The mobile UE may associate channel estimations of signals from the RSUs to the RSUs indicated in the decoded SNL message using the RSU ID (e.g., source ID) as the key.

Identifying the synchronization source from among the plurality of UEs in accordance with the first or second indication(s) may enable a mobile UE (e.g., a vehicle driving through a tunnel) to switch to an optimal RSU. For example, the mobile UE may switch to an RSU that the mobile UE is approaching (e.g., rather than an RSU that the mobile UE is driving away from). Thus, instead of immediately switching synchronization sources upon detecting a signal from an RSU (the mobile UE may have little time to reselect synchronization sources while driving by RSUs), the mobile UE may switch to an optimal RSU. Furthermore, the mobile UE may be able to perform channel estimations over larger transport blocks (TBs) more easily than performing channel estimations over six resource blocks (RBs), which is the size of a PSBCH TB.

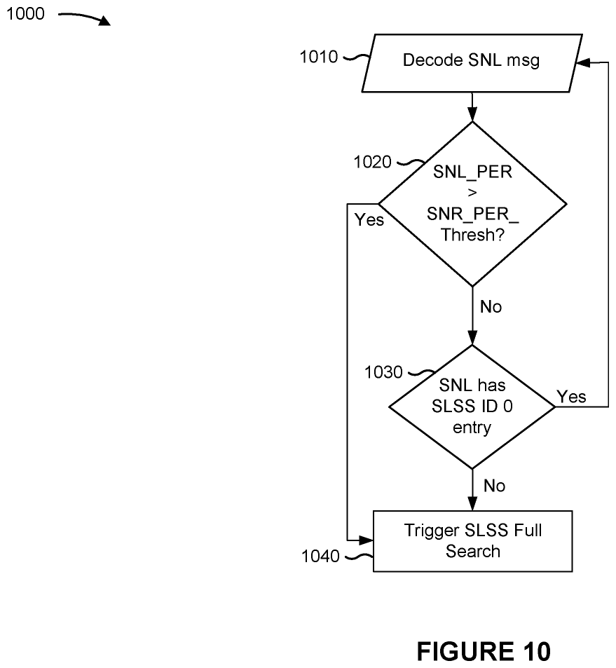

FIG. 10 is a diagram illustrating an example 1000 associated with mitigating (e.g., eliminating) deadlock, in accordance with the present disclosure.

As shown by reference number 1010, a UE (e.g., an RSU) that has entered a deadlock scenario may continue to decode SNL messages. As shown by reference number 1020, the UE may determine whether a packet error rate exceeds a threshold (e.g., whether SNL_Rx_PER>SNL_PER_Thresh). SNL_PER_Thresh may be a factor of the quantity of neighboring SLSS transmitting UEs and the SNL message generation rate. For example, SNLs from two devices may be expected, meaning two SNLs are expected every X ms.

As shown by reference number 1030, responsive to the packet error rate exceeding the threshold, the UE may trigger an SLSS search. As shown by reference number 1040, responsive to the packet error rate not exceeding the threshold, the UE may determine whether the SNL includes any SLSS identifier associated with a navigation-system-synchronized UE (or with another UE of the plurality of UEs that is synchronized to the navigation-system-synchronized UE). For example, the UE may determine whether the SNL contains an SLSS ID 0 entry.

As shown by reference number 1030, responsive to the SNL not including any SLSS identifier associated with a navigation-system-synchronized UE (or with another UE of the plurality of UEs that is synchronized to the navigation-system-synchronized UE), the UE may trigger an SLSS search. In some examples, the UE may trigger an SLSS search based on the SNL containing information relating to only one other UE. As shown by reference number 1010, responsive to the SNL including any SLSS identifier associated with a navigation-system-synchronized UE (or with another UE of the plurality of UEs that is synchronized to the navigation-system-synchronized UE), the UE may continue decoding SNL messages.

Triggering an SLSS search may help the UE to break from the deadlock scenario. For example, the UE may drop the current synchronization source and search for an updated synchronization source that is connected (directly or indirectly) to the GNSS. For example, triggering the SLSS search responsive to a packet error rate exceeding a threshold may enable the UE to break from the deadlock scenario because a high packet error rate may indicate that the UE is drifting in time (e.g., due to a deadlock scenario). Triggering the SLSS search responsive to the SNL not including any SLSS identifier associated with a navigation-system-synchronized UE (or with another UE of the plurality of UEs that is synchronized to the navigation-system-synchronized UE) may enable the UE to break from the deadlock scenario because an absence of an SLSS ID 0 entry indicates that none of the UEs with which the UE can directly or indirectly communicate are in direct or indirect communication with a GNSS.

FIG. 11 is a diagram illustrating an example 1100 associated with cloud-based implementations, in accordance with the present disclosure.

As shown, a UE (e.g., RSU A or B) may transmit, to a cloud or a network, an indication that includes at least an SLSS ID associated with the UE and an indication of a relative position of the UE within a plurality of UEs (e.g., a plurality of RSUs). For example, RSUs connected to GPS and to WAN may be able to upload an entire SNL to the cloud for that region. Additionally, or alternatively, other RSUs may upload respective SNLs to the cloud or the network, if the RSUs have the capability to do so. Additionally, or alternatively, a UE (e.g., RSUs A-E) may receive, from the cloud or the network, an indication that includes at least an SLSS ID associated with a neighboring UE (e.g., a neighboring RSU) and an indication of a relative position of the neighboring UE within the plurality of UEs.

Transmitting and/or receiving the indication(s) to/from the cloud or the network may help to reduce the inter-transmit time of the indication (e.g., SNL message), as the RSUs may receive untruncated SNLs from the cloud. Moreover, transmitting the indication (e.g., SNL message) to the cloud or the network may enable the cloud or the network to transmit an SNL message to a mobile UE. For example, the cloud or the network may transmit the SNL message in a network-to-vehicle (N2V), or vehicle-to-network (V2N), message or using a car-to-cloud (Car2Cloud) system. For example, an OBU that is about to enter the tunnel may download the SNL, ahead of time, from the cloud through a Car2Cloud system or from the network via V2N messaging.

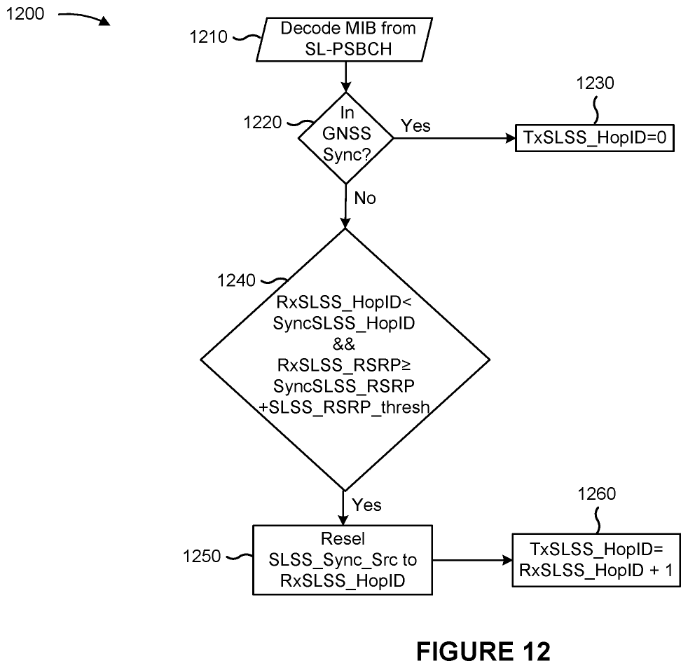

FIG. 12 is a diagram illustrating an example 1200 associated with determining a hop ID for a UE, in accordance with the present disclosure. The hop ID may indicate a quantity of hops away from a UE (e.g., an SLSS-transmitting UE, such as an RSU) connected directly to GNSS that another UE (e.g., another RSU) is.

As shown by reference number 1210, the UE may receive a hop ID in a master information block (MIB), which may reduce complexity and uncertainty associated with choosing an RSU based on TO estimation. For example, the UE may decode a sidelink MIB (SL-MIB) from the PSBCH. An SLSS hop identifier may be added to at least a portion of the 27 reserved bits (currently set to all zeros) in an SLSS MIB as follows:

| | |
|---|---|
| MasterInformationBlock-SL ::= | SEQUENCE { |
| sl-Bandwidth-r12 | ENUMERATED { |
| | n6, n15, n25, n50, n75, n100}, |
| tdd-ConfigSL-r12 | TDD-ConfigSL-r12, |
| directFrameNumber-r12 | BIT STRING (SIZE (10)), |
| directSubframeNumber-r12 | INTEGER (0..9), |
| inCoverage-r12 | BOOLEAN, |
| hopID | BIT STRING |
| reserved-r12 | BIT STRING |

}

As shown by reference number 1220, the UE may determine whether the UE is directly connected to the GNSS (e.g., whether the UE has priority P1). As shown by reference number 1230, if the UE is directly connected to the GNSS, then the UE may automatically set the hop ID (“hopID”) that the UE will transmit in the SL-MIB (“TxSLSS_HopID”) to zero.

The UE may automatically derive the hop ID based on the SLSS synchronization source of the UE. For example, the UE may automatically derive the hop ID if the UE is not directly connected to the GNSS and the SLSS synchronization source SL-MIB contains a hop ID. As shown by reference number 1240, if the UE is not directly connected to the GNSS, then the UE (e.g., an SLSS-receiving UE) may identify an SLSS synchronization source that has the smallest hop ID among hop IDs of all SLSS synchronization sources detected by the UE and that has the best SLSS RSRP. “RxSLSS_HopID” (which may be decoded from the MIB) may be the hop ID of the SLSS synchronization source that the UE will switch to, “SyncSLSS_HopID” may be the hop ID of the current SLSS synchronization source, “RxSLSS_RSRP” may be the RSRP associated with the SLSS synchronization source that the UE will switch to, “SyncSLSS_RSRP” may be the RSRP associated with the current SLSS synchronization source, and “SLSS_RSRP_thresh” may be a threshold.

As shown by reference number 1250, the UE may reselect SLSS synchronization sources. For example, the UE may switch from the current SLSS synchronization source that the UE is using (“SLSS_sync_Src”) to the SLSS synchronization source that the UE will switch to (“RxSLSS_HopID”). For example, if the UE detects an SLSS from a transmitter that has a lower hop ID than the hop ID of a current SLSS synchronization source, and/or the transmitter meets certain criteria, then the UE may perform SLSS synchronization source reselection. If the UE detects multiple identical hop IDs, then the UE may choose the synchronization source based on the synchronization source meeting certain criteria.

As shown by reference number 1260, a value of the hop ID of the UE may be incremented from a value of a hop ID associated with a neighboring UE (e.g., the hop ID may be increased based on the neighboring UE that the UE is currently synchronized to). For example, the UE may increment the RxSLSS_HopID (e.g., the hop ID associated with the neighboring UE) by one to generate the hop ID for the UE (“TxSLSS_HopID”). The UE may set the TxSLSS_HopID in the SL-MIB when transmitting the SLSS. If the UE is not directly connected to the GNSS and the SLSS synchronization source SL-MIB does not contain a hop ID, then the UE may not populate the HopID field in the MIB when transmitting the SLSS. If the UE detects synchronization sources with and without hop IDs, and the synchronization sources do not correspond to SLSS ID 0, then the UE may prioritize the SLSS synchronization source with a hop ID.

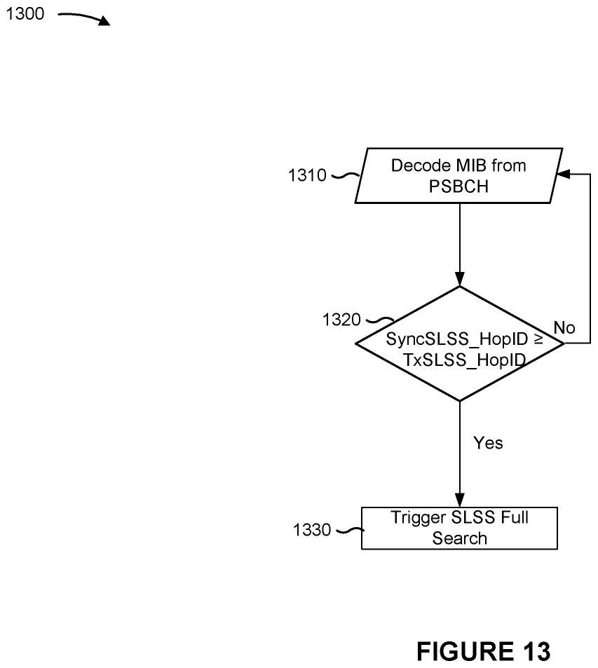

FIG. 13 is a diagram illustrating an example 1300 associated with mitigating (e.g., eliminating) deadlock using a hop ID, in accordance with the present disclosure.

As shown by reference number 1310, the UE may decode a MIB from the PSBCH and identify a hop ID associated with another UE, such as a neighboring UE (“SyncSLSS_HopID”). As shown by reference number 1320, the UE may determine whether the SyncSLSS_HopID is greater than or equal to the TxSLSS_HopID. If the SyncSLSS_HopID is less than the TxSLSS_HopID, then the UE may decode additional MIBs from the PSBCH, as shown by reference number 1310.

As shown by reference number 1330, the UE may trigger an SLSS search responsive to a value of the hop ID associated with the UE being less than or equal to a value of a hop identifier of another UE for a configured time duration. For example, the configured time duration may be a duration of an SLSS deadlock timer.

Triggering the SLSS search responsive to a value of the hop ID associated with the UE being less than or equal to a value of a hop identifier of another UE for a configured time duration may help the UE to break out of the deadlock. For example, the value of the hop ID associated with the UE being less than or equal to the value of the hop identifier of the other UE for at least the configured time duration may indicate that the UE is in a synchronization deadlock. Example 1300 may be implemented on any UE that can detect a hop ID greater than or equal than the hop ID that the UE is using as the TxSLSS_HopID for that UE.

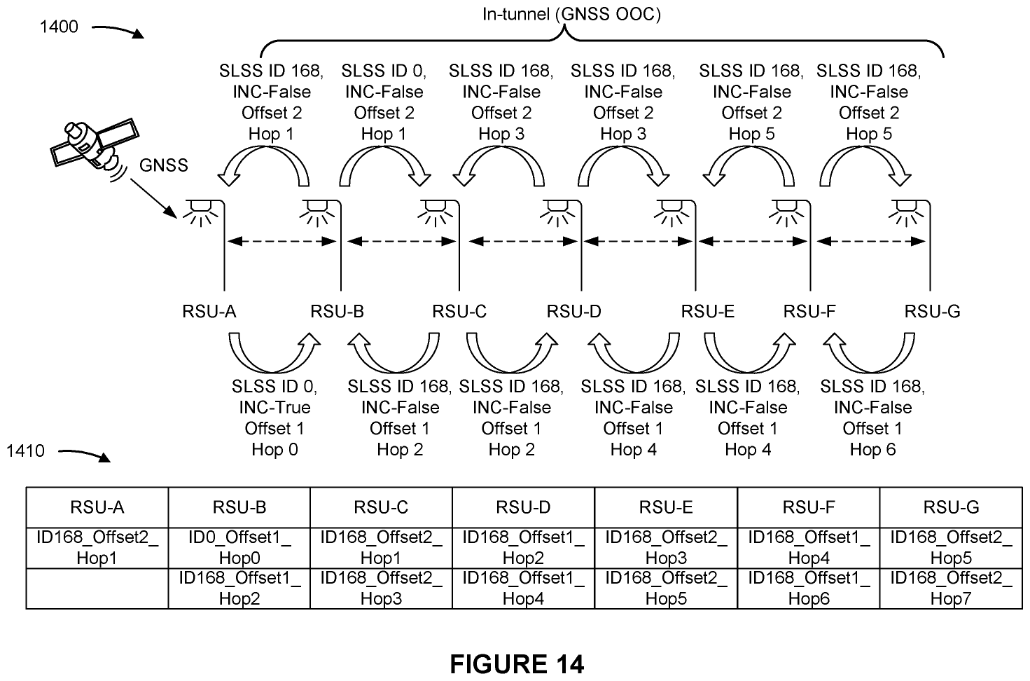

FIG. 14 is a diagram illustrating an example 1400 associated with SLSS propagation in a daisy chain using a hop ID, in accordance with the present disclosure. As shown in FIG. 14, an RSU deep inside a tunnel (e.g., RSU G) may be time-synchronized with the rest of the system (e.g., RSUs A-F and the GNSS). The arrows pointing left-to-right represent target propagation of SLSSs, and the arrows pointing right-to-left represent leakage (e.g., undesirable reception of SLSSs) from adjacent SLSS sources. Example 1400 shows the timing availability when all of the RSUs are up. As shown in table 1410, the RSUs (e.g., SLSS-transmitting UEs) may be uniquely identified, even when the SLSS IDs are the same, based on the hop IDs.

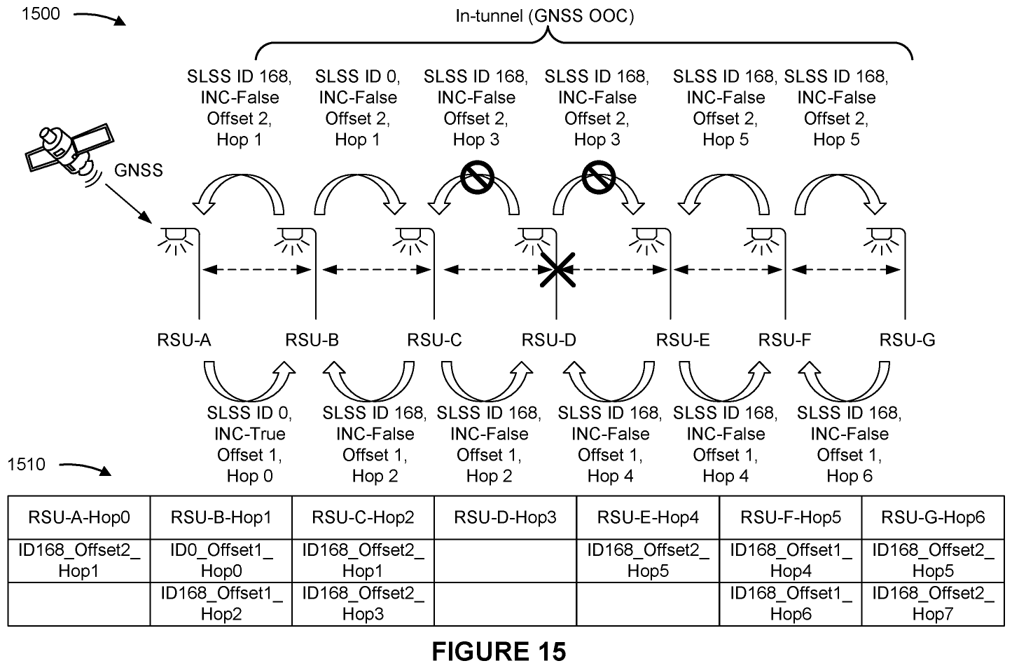

FIG. 15 is a diagram illustrating an example 1500 of a deadlock scenario involving hop IDs, in accordance with the present disclosure. In example 1500, RSU D may go down. Before going down, RSU D may have detected only one hop ID greater than the hop ID that RSU D was using for transmission. Example 1500 shows the timing availability when RSU D is not transmitting an SLSS. As a result, as shown in table 1510, the RSU E may trigger an SLSS search and stop transmitting an SLSS with hop ID 4.

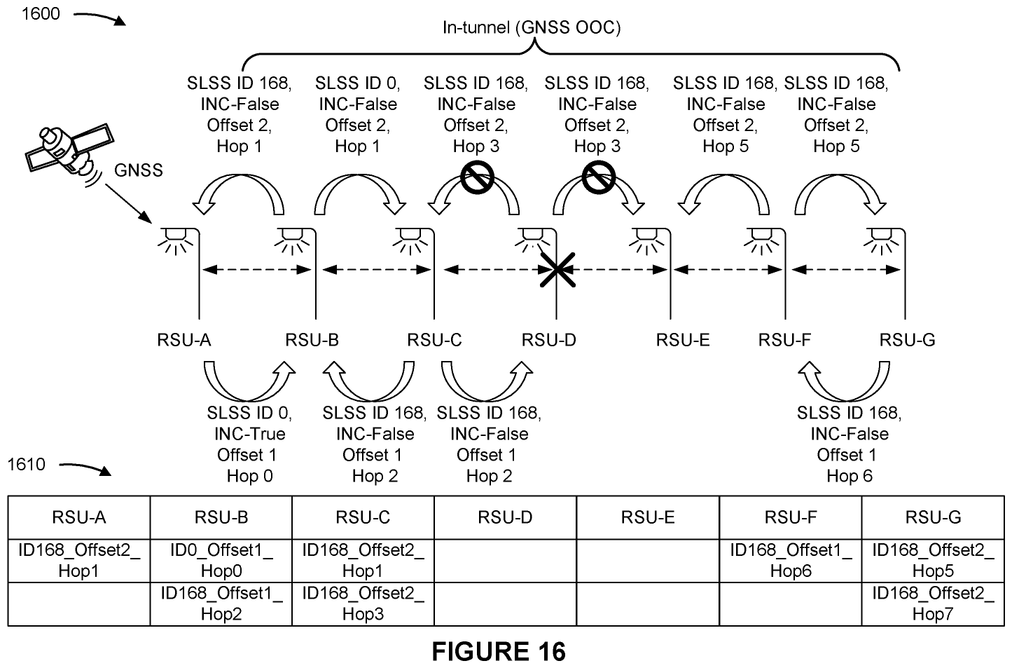

FIG. 16 is a diagram illustrating an example 1600 of a continuation of the deadlock scenario involving hop IDs, in accordance with the present disclosure. As shown, RSU F may detect only hop IDs greater than the hop ID that the RSU F is using for transmission. As a result, the RSU F may trigger an SLSS search. Example 1600, and table 1610, show the timing availability with RSU E in search mode.

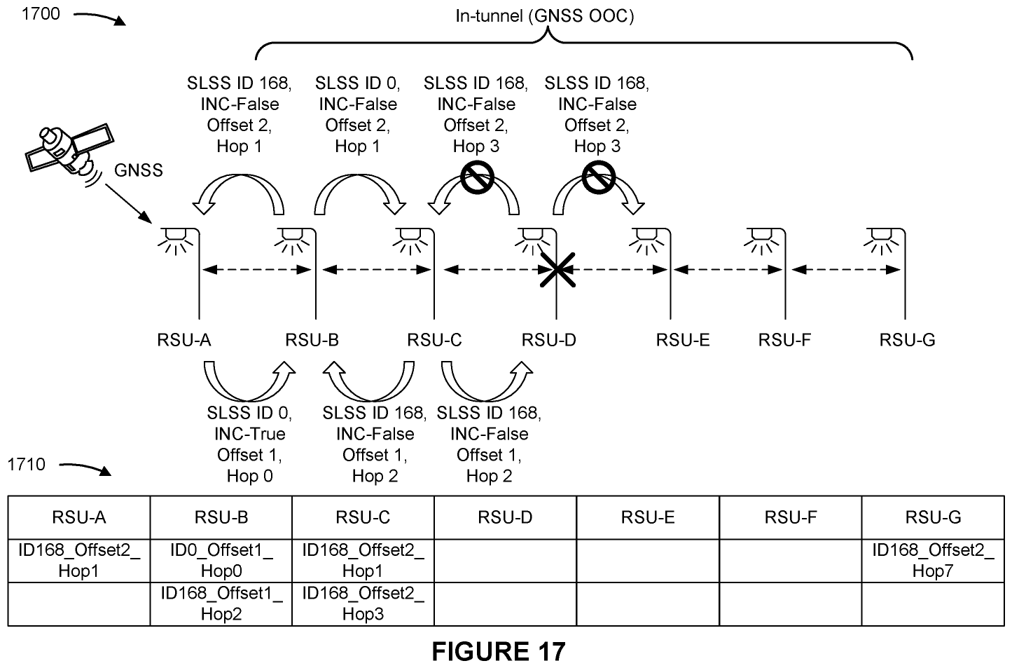

FIG. 17 is a diagram illustrating an example 1700 of a further continuation of the deadlock scenario involving hop IDs, in accordance with the present disclosure. As shown, RSU G may detect only hop IDs greater than the hop ID that the RSU G is using for transmission. As a result, the RSU G may trigger an SLSS search. Example 1700, and table 1710, show the timing availability with RSU E in search mode.

When RSU D comes back online, RSU D will automatically choose an appropriate hop ID, and other devices in the daisy chain (e.g., RSUs E-G) may dynamically realign the associated hop IDs. Thus, the hop ID may help to prevent devices from synchronizing among one another in the absence of a link to a GNSS-synchronized UE, and thus avoid a deadlock. The hop ID may resolve deadlock scenarios for LTE V2X SLSS synchronization, NR V2X SLSS, or the like.

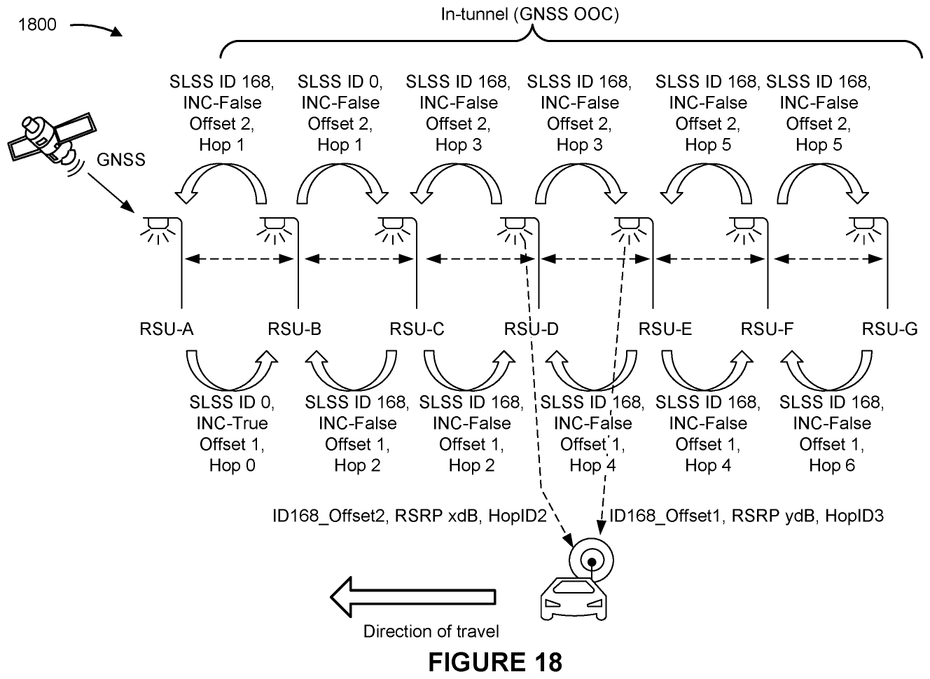

FIG. 18 is a diagram illustrating an example 1800 of synchronization source selection, in accordance with the present disclosure.

In example 1800, an OBU may choose a lowest hop ID, which may be associated with an RSU having a lowest TO. For example, the OBU may select RSU D over RSU E. The hop ID may assist the OBU in choosing the SLSS synchronization source that has the smallest timing offset. For example, the hop ID may help an SLSS-receiving UE (e.g., the OBU) to determine how far away the UE is from the true timing reference (e.g., the GNSS-synchronized UE) and thus enable the OBU to choose an optimal synchronization source. As a result, the modem (e.g., associated with the OBU) may choose the SLSS synchronization source associated with a UE (e.g., an RSU) that is closer to the UE than other UEs based on the decoded PSBCH (e.g., and not based on only the RSRP) for identical SLSS IDs. The hop ID being in the SL-MIB may eliminate synchronization source selection based on TO estimation, which can vary based on channel conditions and is therefore unreliable.

FIG. 19 is a flowchart illustrating an example process 1900 performed, for example, by a UE that supports indicating a relative position and SLSS ID of the UE in accordance with the present disclosure. Example process 1900 is an example where the UE (for example, UE 120) performs operations associated with indicating a relative position and SLSS ID of the UE.

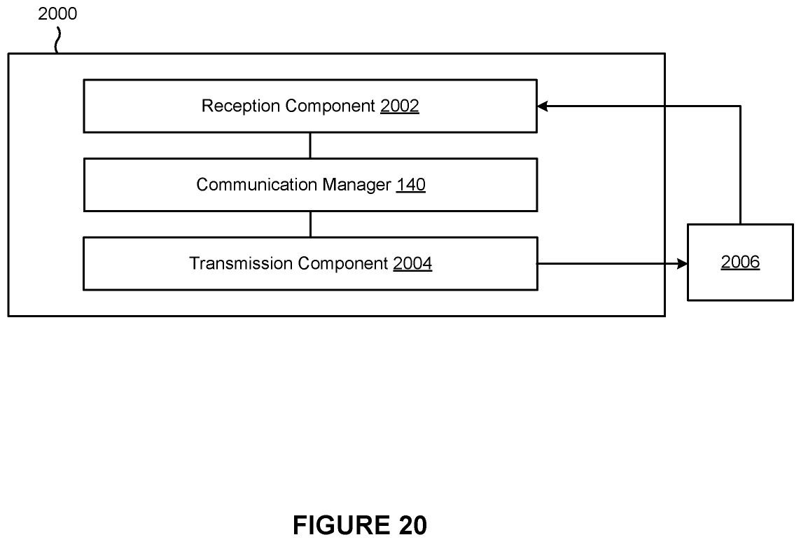

As shown in FIG. 19, in some aspects, process 1900 may include receiving a first indication including at least an SLSS identifier associated with a neighboring UE of the UE and an indication of a relative position of the neighboring UE within a plurality of UEs (block 1910). For example, the UE (such as by using communication manager 140 or reception component 2002, depicted in FIG. 20) may receive a first indication including at least an SLSS identifier associated with a neighboring UE of the UE and an indication of a relative position of the neighboring UE within a plurality of UEs, as described above.

As further shown in FIG. 19, in some aspects, process 1900 may include transmitting a second indication including at least an SLSS identifier associated with the UE and an indication of a relative position of the UE within the plurality of UEs (block 1920). For example, the UE (such as by using communication manager 140 or transmission component 2004, depicted in FIG. 20) may transmit a second indication including at least an SLSS identifier associated with the UE and an indication of a relative position of the UE within the plurality of UEs, as described above.

Process 1900 may include additional aspects, such as any single aspect or any combination of aspects described below or in connection with one or more other processes described elsewhere herein.

In a first additional aspect, the indication of the relative position of the UE includes an identifier of the UE.

In a second additional aspect, alone or in combination with the first aspect, the identifier of the UE is an RSU ID.

In a third additional aspect, alone or in combination with one or more of the first and second aspects, the indication of the relative position of the UE includes a hop ID associated with the UE.

In a fourth additional aspect, alone or in combination with one or more of the first through third aspects, receiving the hop ID includes receiving the hop ID in a MIB.

In a fifth additional aspect, alone or in combination with one or more of the first through fourth aspects, the hop ID is a first hop ID, and a first value of the first hop ID is incremented from a second value of a second hop ID associated with the neighboring UE.

In a sixth additional aspect, alone or in combination with one or more of the first through fifth aspects, the hop identifier is a first hop identifier, and the process 1900 further includes triggering an SLSS search responsive to a first value of the first hop ID being less than or equal to a second value of a second hop ID of one UE of the plurality of UEs for a configured time duration.

In a seventh additional aspect, alone or in combination with one or more of the first through sixth aspects, the indication of the relative position of the UE includes an indication of a geographic location of the UE.

In an eighth additional aspect, alone or in combination with one or more of the first through seventh aspects, the indication of the relative position of the neighboring UE includes an identifier of the neighboring UE.

In a ninth additional aspect, alone or in combination with one or more of the first through eighth aspects, the indication of the relative position of the neighboring UE includes a hop ID associated with the neighboring UE.

In a tenth additional aspect, alone or in combination with one or more of the first through ninth aspects, the indication of the relative position of the neighboring UE includes an indication of a geographic location of the neighboring UE.

In an eleventh additional aspect, alone or in combination with one or more of the first through tenth aspects, the second indication further includes one or more of an index, an indication of whether the UE is in coverage of a navigation system, a transmission synchronization offset associated with the UE, or an indication of a first time derived from a second time associated with the neighboring UE.

In a twelfth additional aspect, alone or in combination with one or more of the first through eleventh aspects, the indication of the relative position of the UE includes one or more of an identifier of the UE, a hop ID associated with the UE, an indication of a geographic location of the UE, or a synchronization source indication corresponding to the neighboring UE.

In a thirteenth additional aspect, alone or in combination with one or more of the first through twelfth aspects, the first indication comprises a first list that associates a first index with the SLSS identifier associated with the neighboring UE and with the indication of the relative position of the neighboring UE.

In a fourteenth additional aspect, alone or in combination with one or more of the first through thirteenth aspects, the plurality of UEs are in SLSS synchronization and transmit, via a PSSCH once every one or more SLSS cycles, a plurality of lists, including the first list and the second list, that include indications of a plurality of synchronization sources.

In a fifteenth additional aspect, alone or in combination with one or more of the first through fourteenth aspects, process 1900 includes generating the second list by appending information to the first list.

In a sixteenth additional aspect, alone or in combination with one or more of the first through fifteenth aspects, generating the second list by appending information to the first list includes appending information to the first list using the first index.

In a seventeenth additional aspect, alone or in combination with one or more of the first through sixteenth aspects, process 1900 includes triggering an SLSS search responsive to a packet error rate exceeding a threshold.

In an eighteenth additional aspect, alone or in combination with one or more of the first through seventeenth aspects, process 1900 includes triggering an SLSS search responsive to the first indication not including any SLSS identifier associated with a navigation-system-synchronized UE of the plurality of UEs or with another UE of the plurality of UEs that is synchronized to the navigation-system-synchronized UE.

In a nineteenth additional aspect, alone or in combination with one or more of the first through eighteenth aspects, the first indication further includes a first indication of a first time, and the second indication further includes a second indication of a second time derived from the first time.

In a twentieth additional aspect, alone or in combination with one or more of the first through nineteenth aspects, process 1900 includes identifying one or more parameters of one or more SLSS transmissions based at least in part on the first indication.

In an twenty-first additional aspect, alone or in combination with one or more of the first through twentieth aspects, a mobile UE identifies a synchronization source from among the plurality of UEs in accordance with the first indication or the second indication.

In a twenty-second additional aspect, alone or in combination with one or more of the first through twenty-first aspects, the neighboring UE is a first neighboring UE, and receiving the first indication includes receiving the first indication from the first neighboring UE, or transmitting the second indication includes transmitting the second indication to a second neighboring UE.

In a twenty-third additional aspect, alone or in combination with one or more of the first through twenty-second aspects, receiving the first indication includes receiving the first indication from a cloud or a network, or transmitting the second indication includes transmitting the second indication to the cloud or the network.

In a twenty-fourth additional aspect, alone or in combination with one or more of the first through twenty-third aspects, process 1900 includes deriving a UTC time associated with the UE using a UTC time, associated with the neighboring UE, carried in the first indication and generating the second indication by appending the UTC time associated with the UE to the first indication.

In a twenty-fifth additional aspect, alone or in combination with one or more of the first through twenty-fourth aspects, process 1900 includes decoding a plurality of indications including the first indications and identifying a UTC time from an indication, of the plurality of indications, that the UE decoded more recently than any other indications of the plurality of indications.

In a twenty-sixth additional aspect, alone or in combination with one or more of the first through twenty-fifth aspects, process 1900 includes identifying overlapping SLSS transmissions using the first indication.

Although FIG. 19 shows example blocks of process 1900, in some aspects, process 1900 may include additional blocks, fewer blocks, different blocks, or differently arranged blocks than those depicted in FIG. 19. Additionally or alternatively, two or more of the blocks of process 1900 may be performed in parallel.

FIG. 20 is a diagram of an example apparatus 2000 for wireless communication that supports indicating a relative position and an SLSS ID for a UE, in accordance with the present disclosure. The apparatus 2000 may be a UE, or a UE may include the apparatus 2000. In some aspects, the apparatus 2000 includes a reception component 2002, a transmission component 2004, and a communication manager 140, which may be in communication with one another (for example, via one or more buses). As shown, the apparatus 2000 may communicate with another apparatus 2006 (such as a UE, a network node, or another wireless communication device) using the reception component 2002 and the transmission component 2004.

In some aspects, the apparatus 2000 may be configured to and/or operable to perform one or more operations described herein in connection with FIG. 7-18. Additionally or alternatively, the apparatus 2000 may be configured to and/or operable to perform one or more processes described herein, such as process 1900 of FIG. 19. In some aspects, the apparatus 2000 may include one or more components of the UE described above in connection with FIG. 2.

The reception component 2002 may receive communications, such as reference signals, control information, and/or data communications, from the apparatus 2006. The reception component 2002 may provide received communications to one or more other components of the apparatus 2000, such as the communication manager 140. In some aspects, the reception component 2002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components. In some aspects, the reception component 2002 may include one or more antennas, a modem, a demodulator, a MIMO detector, a receive processor, a controller/processor, and/or a memory of the UE described above in connection with FIG. 2.

The transmission component 2004 may transmit communications, such as reference signals, control information, and/or data communications, to the apparatus 2006. In some aspects, the communication manager 140 may generate communications and may transmit the generated communications to the transmission component 2004 for transmission to the apparatus 2006. In some aspects, the transmission component 2004 may perform signal processing on the generated communications (such as filtering, amplification, modulation, digital-to-analog conversion, multiplexing, interleaving, mapping, or encoding, among other examples), and may transmit the processed signals to the apparatus 2006. In some aspects, the transmission component 2004 may include one or more antennas, a modem, a modulator, a transmit MIMO processor, a transmit processor, a controller/processor, and/or a memory of the UE described above in connection with FIG. 2. In some aspects, the transmission component 2004 may be co-located with the reception component 2002 in a transceiver.

The communication manager 140 may receive or may cause the reception component 2002 to receive a first indication including at least an SLSS ID associated with a neighboring UE of the UE and an indication of a relative position of the neighboring UE within a plurality of UEs. The communication manager 140 may transmit or may cause the transmission component 2004 to transmit a second indication including at least an SLSS identifier associated with the UE and an indication of a relative position of the UE within the plurality of UEs. In some aspects, the communication manager 140 may perform one or more operations described elsewhere herein as being performed by one or more components of the communication manager 140. The communication manager 140 may include a controller/processor and/or a memory of the UE described above in connection with FIG. 2.

The reception component 2002 may receive a first indication including at least an SLSS ID associated with a neighboring UE of the UE and an indication of a relative position of the neighboring UE within a plurality of UEs. The transmission component 2004 may transmit a second indication including at least an SLSS ID associated with the UE and an indication of a relative position of the UE within the plurality of UEs.

The communication manager 140 may trigger an SLSS search responsive to a packet error rate exceeding a threshold.

The communication manager 140 may trigger an SLSS search responsive to the first indication not including any SLSS ID associated with a navigation-system-synchronized UE of the plurality of UEs or with another UE of the plurality of UEs that is synchronized to the navigation-system-synchronized UE.

The communication manager 140 may identify one or more parameters of one or more SLSS transmissions based at least in part on the first indication.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally or alternatively, a set of (one or more) components shown in FIG. 20 may perform one or more functions described as being performed by another set of components shown in FIG. 20.

The following provides an overview of some Aspects of the present disclosure:

Aspect 1: A method of wireless communication performed at a UE, comprising: receiving a first indication including at least an SLSS identifier associated with a neighboring UE of the UE and an indication of a relative position of the neighboring UE within a plurality of UEs; and transmitting a second indication including at least an SLSS identifier associated with the UE and an indication of a relative position of the UE within the plurality of UEs.

Aspect 2: The method of Aspect 1, wherein the indication of the relative position of the UE includes an identifier of the UE.

Aspect 3: The method of Aspect 2, wherein the identifier of the UE is an RSU identifier.

Aspect 4: The method of any of Aspects 1-3, wherein the indication of the relative position of the UE includes a hop identifier associated with the UE.

Aspect 5: The method of Aspect 4, wherein receiving the hop identifier includes receiving the hop identifier in a MIB.

Aspect 6: The method of Aspect 4, wherein the hop identifier is a first hop identifier, and wherein a first value of the first hop identifier is incremented from a second value of a second hop identifier associated with the neighboring UE.

Aspect 7: The method of Aspect 4, wherein the hop identifier is a first hop identifier, the method further comprising: triggering an SLSS search responsive to a first value of the first hop identifier being less than or equal to a second value of a second hop identifier of one UE of the plurality of UEs for a configured time duration.

Aspect 8: The method of any of Aspects 1-7, wherein the indication of the relative position of the UE includes an indication of a geographic location of the UE.

Aspect 9: The method of any of Aspects 1-8, wherein the indication of the relative position of the neighboring UE includes an identifier of the neighboring UE.

Aspect 10: The method of any of Aspects 1-9, wherein the indication of the relative position of the neighboring UE includes a hop identifier associated with the neighboring UE.

Aspect 11: The method of any of Aspects 1-10, wherein the indication of the relative position of the neighboring UE includes an indication of a geographic location of the neighboring UE.

Aspect 12: The method of any of Aspects 1-11, wherein the second indication further includes one or more of: an index; an indication of whether the UE is in coverage of a navigation system; a transmission synchronization offset associated with the UE; or an indication of a first time derived from a second time associated with the neighboring UE.

Aspect 13: The method of any of Aspects 1-12, wherein the indication of the relative position of the UE includes one or more of: an identifier of the UE; a hop identifier associated with the UE; an indication of a geographic location of the UE; or a synchronization source indication corresponding to the neighboring UE.

Aspect 14: The method of any of Aspects 1-13, wherein the first indication comprises a first list that associates a first index with the SLSS identifier associated with the neighboring UE and with the indication of the relative position of the neighboring UE.

Aspect 15: The method of Aspect 14, wherein the second indication comprises a second list that associates the first index with the SLSS identifier associated with the UE and with the indication of the relative position of the UE, and wherein the second list further associates a second index with the SLSS identifier associated with the neighboring UE and associated with the indication of the relative position of the neighboring UE.

Aspect 16: The method of Aspect 15, wherein the plurality of UEs are in SLSS synchronization and transmit, via a PSSCH once every one or more SLSS cycles, a plurality of lists, including the first list and the second list, that include indications of a plurality of synchronization sources.

Aspect 17: The method of Aspect 15, further comprising: generating the second list by appending information to the first list.

Aspect 18: The method of any of Aspects 17, wherein generating the second list by appending information to the first list includes appending the information to the first list using the first index.

Aspect 19: The method of any of Aspects 1-18, further comprising: deriving a UTC time associated with the UE using a UTC time, associated with the neighboring UE, carried in the first indication; and generating the second indication by appending the UTC time associated with the UE to the first indication.

Aspect 20: The method of any of Aspects 1-19, further comprising: decoding a plurality of indications including the first indications; and identifying a UTC time from an indication, of the plurality of indications, that the UE decoded more recently than any other indications of the plurality of indications.

Aspect 21: The method of any of Aspects 1-20, further comprising: identifying overlapping SLSS transmissions using the first indication.

Aspect 22: The method of any of Aspects 1-21, further comprising: triggering an SLSS search responsive to a packet error rate exceeding a threshold.

Aspect 23: The method of any of Aspects 1-22, further comprising: triggering an SLSS search responsive to the first indication not including any SLSS identifier associated with a navigation-system-synchronized UE of the plurality of UEs or with another UE of the plurality of UEs that is synchronized to the navigation-system-synchronized UE.

Aspect 24: The method of any of Aspects 1-23, wherein the first indication further includes a first indication of a first time, and wherein the second indication further includes a second indication of a second time derived from the first time.

Aspect 25: The method of Aspect 24, wherein the first time is a first UTC time, and wherein the second time is a second UTC time.

Aspect 26: The method of any of Aspects 1-25, further comprising: identifying one or more parameters of one or more SLSS transmissions based at least in part on the first indication.

Aspect 27: The method of any of Aspects 1-26, wherein a mobile UE identifies a synchronization source from among the plurality of UEs in accordance with the first indication or the second indication.

Aspect 28: The method of any of Aspects 1-27, wherein the neighboring UE is a first neighboring UE, and wherein receiving the first indication includes receiving the first indication from the first neighboring UE, or transmitting the second indication includes transmitting the second indication to a second neighboring UE.

Aspect 29: The method of any of Aspects 1-28, wherein receiving the first indication includes receiving the first indication from a cloud or a network, or transmitting the second indication includes transmitting the second indication to the cloud or the network.

Aspect 30: An apparatus for wireless communication at a device, comprising a processor; memory coupled with the processor; and instructions stored in the memory and executable by the processor to cause the apparatus to perform the method of one or more of Aspects 1-29.

Aspect 31: A device for wireless communication, comprising a memory and one or more processors coupled to the memory, the one or more processors configured to perform the method of one or more of Aspects 1-29.

Aspect 32: An apparatus for wireless communication, comprising at least one means for performing the method of one or more of Aspects 1-29.

Aspect 33: A non-transitory computer-readable medium storing code for wireless communication, the code comprising instructions executable by a processor to perform the method of one or more of Aspects 1-29.

Aspect 34: A non-transitory computer-readable medium storing a set of instructions for wireless communication, the set of instructions comprising one or more instructions that, when executed by one or more processors of a device, cause the device to perform the method of one or more of Aspects 1-29.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (for example, if used in combination with “either” or “only one of”).

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive a first indication including at least a sidelink synchronization signal (SLSS) identifier associated with a neighboring UE of the UE and an indication of a relative position of the neighboring UE within a plurality of UEs; and
transmit a second indication including at least an SLSS identifier associated with the UE and an indication of a relative position of the UE within the plurality of UEs.

2. The apparatus of claim 1, wherein the indication of the relative position of the UE includes an identifier of the UE or an indication of a geographic location of the UE.

3. The apparatus of claim 2, wherein the identifier of the UE is a roadside unit (RSU) identifier.

4. The apparatus of claim 1, wherein the indication of the relative position of the UE includes a hop identifier associated with the UE, and wherein the at least one processor of the one of the one or more processors, to receive the hop identifier, is configured to cause the UE to receive the hop identifier in a master information block (MIB).

5. The apparatus of claim 4, wherein the hop identifier is a first hop identifier, and wherein a first value of the first hop identifier is incremented from a second value of a second hop identifier associated with the neighboring UE.

6. The apparatus of claim 4, wherein the hop identifier is a first hop identifier, and wherein the at least one processor of the one of the one or more processors is configured to cause the UE to:
trigger an SLSS search responsive to a first value of the first hop identifier being less than or equal to a second value of a second hop identifier of one UE of the plurality of UEs for a configured time duration.

7. The apparatus of claim 1, wherein the indication of the relative position of the neighboring UE includes an identifier of the neighboring UE, a hop identifier associated with the neighboring UE, or an indication of a geographic location of the neighboring UE.

8. The apparatus of claim 1, wherein the second indication further includes one or more of:
an index;
an indication of whether the UE is in coverage of a navigation system;
a transmission synchronization offset associated with the UE; or
an indication of a first time derived from a second time associated with the neighboring UE.

9. The apparatus of claim 1, wherein the indication of the relative position of the UE includes one or more of:
an identifier of the UE;
a hop identifier associated with the UE;
an indication of a geographic location of the UE; or
a synchronization source indication corresponding to the neighboring UE.

10. The apparatus of claim 1, wherein the first indication comprises a first list that associates a first index with the SLSS identifier associated with the neighboring UE and with the indication of the relative position of the neighboring UE.

11. The apparatus of claim 10, wherein the second indication comprises a second list that associates the first index with the SLSS identifier associated with the UE and with the indication of the relative position of the UE, and wherein the second list further associates a second index with the SLSS identifier associated with the neighboring UE and associated with the indication of the relative position of the neighboring UE.

12. The apparatus of claim 11, wherein the plurality of UEs are in SLSS synchronization and transmit, via a physical sidelink shared channel (PSSCH) once every one or more SLSS cycles, a plurality of lists, including the first list and the second list, that include indications of a plurality of synchronization sources.

13. The apparatus of claim 11, wherein at least one processor is configured to cause the UE to:
generate the second list by appending information to the first list.

14. The apparatus of claim 13, wherein the at least one processor configured to cause the UE to generate the second list by appending information to the first list is configured to cause the UE to:
append information to the first list using the first index.

15. The apparatus of claim 1, wherein at least one processor of the one or more processors is configured to cause the UE to:
derive a coordinated universal time (UTC) time associated with the UE using a UTC time, associated with the neighboring UE, carried in the first indication; and
generate the second indication by appending the UTC time associated with the UE to the first indication.

16. The apparatus of claim 1, wherein at least one processor of the one or more processors is configured to cause the UE to:
decode a plurality of indications including the first indication; and
identify a coordinated universal time (UTC) time from an indication, of the plurality of indications, that the UE decoded more recently than any other indications of the plurality of indications.

17. The apparatus of claim 1, wherein at least one processor of the one or more processors is configured to cause the UE to:
identify overlapping SLSS transmissions using the first indication.

18. A method of wireless communication performed at a user equipment (UE), comprising:
receiving a first indication including at least a sidelink synchronization signal (SLSS) identifier associated with a neighboring UE of the UE and an indication of a relative position of the neighboring UE within a plurality of UEs; and
transmitting a second indication including at least an SLSS identifier associated with the UE and an indication of a relative position of the UE within the plurality of UEs.

19. The method of claim 18, further comprising:
triggering an SLSS search responsive to a packet error rate exceeding a threshold.

20. The method of claim 18, further comprising:
triggering an SLSS search responsive to the first indication not including any SLSS identifier associated with a navigation-system-synchronized UE of the plurality of UEs or with another UE of the plurality of UEs that is synchronized to the navigation-system-synchronized UE.

21. The method of claim 18, wherein the first indication further includes a first indication of a first time, and wherein the second indication further includes a second indication of a second time derived from the first time.

22. The method of claim 21, wherein the first time is a first coordinated universal time (UTC) time, and wherein the second time is a second UTC time.

23. The method of claim 18, further comprising:
identifying one or more parameters of one or more SLSS transmissions based at least in part on the first indication.

24. The method of claim 18, wherein a mobile UE identifies a synchronization source from among the plurality of UEs in accordance with the first indication or the second indication.

25. The method of claim 18, wherein the neighboring UE is a first neighboring UE, and wherein receiving the first indication includes receiving the first indication from the first neighboring UE, or transmitting the second indication includes transmitting the second indication to a second neighboring UE.

26. The method of claim 18, wherein receiving the first indication includes receiving the first indication from a cloud or a network, or transmitting the second indication includes transmitting the second indication to the cloud or the network.

27. The method of claim 18, wherein the first indication comprises a first list that associates a first index with the SLSS identifier associated with the neighboring UE and with the indication of the relative position of the neighboring UE, wherein the second indication comprises a second list that associates the first index with the SLSS identifier associated with the UE and with the indication of the relative position of the UE, wherein the second list further associates a second index with the SLSS identifier associated with the neighboring UE and associated with the indication of the relative position of the neighboring UE, and wherein the plurality of UEs are in SLSS synchronization and transmit, via a physical sidelink shared channel (PSSCH) once every one or more SLSS cycles, a plurality of lists, including the first list and the second list, that include indications of a plurality of synchronization sources.

28. The method of claim 18, wherein the first indication comprises a first list that associates a first index with the SLSS identifier associated with the neighboring UE and with the indication of the relative position of the neighboring UE, wherein the second indication comprises a second list that associates the first index with the SLSS identifier associated with the UE and with the indication of the relative position of the UE, wherein the second list further associates a second index with the SLSS identifier associated with the neighboring UE and associated with the indication of the relative position of the neighboring UE, the method further comprising:
generating the second list by appending information to the first list.

29. The method of claim 28, wherein the first indication comprises a first list that associates a first index with the SLSS identifier associated with the neighboring UE and with the indication of the relative position of the neighboring UE, wherein the second indication comprises a second list that associates the first index with the SLSS identifier associated with the UE and with the indication of the relative position of the UE, wherein the second list further associates a second index with the SLSS identifier associated with the neighboring UE and associated with the indication of the relative position of the neighboring UE, and wherein generating the second list by appending information to the first list includes:
appending the information to the first list using the first index.

30. The method of claim 18, further comprising:
deriving a coordinated universal time (UTC) time associated with the UE using a UTC time, associated with the neighboring UE, carried in the first indication; and
generating the second indication by appending the UTC time associated with the UE to the first indication.

31. The method of claim 18, further comprising:
decoding a plurality of indications including the first indication; and
identifying a coordinated universal time (UTC) time from an indication, of the plurality of indications, that the UE decoded more recently than any other indications of the plurality of indications.

32. The method of claim 18, further comprising:
identifying overlapping SLSS transmissions using the first indication.
